(19) United States
(12) Patent Application Publication
(10) Pub. No.: US 2023/0261870 A1
(43) Pub. Date: Aug. 17, 2023

(54) BLOCKCHAIN AUGMENTED NETWORK PROTOCOL

(71) Applicant: 0Chain Corp., Cupertino, CA (US)

(72) Inventors: Saswata Basu, Cupertino, CA (US); Thomas Howard Austin, San Jose, CA (US)

(21) Appl. No.: 17/672,896

(22) Filed: Feb. 16, 2022

(51) Int. Cl. H04L 9/32; H04L 9/08

(52) U.S. Cl. CPC H04L 9/3213; H04L 9/083; H04L 9/3239; H04L 2209/38; H04L 2209/56

(57) ABSTRACT

An approach is disclosed for supporting an Access Point (AP) connecting to a blockchain platform via a Radius Server communicating with the AP, an operator, and a sponsor to dynamically reward for connectivity services. A glue service is installed on the AP, Provider, and the operator supporting connectivity. The blockchain platform registers an AP and assigns an AP ID which is registered with a randomly selected provider and the radius server monitors the blockchain and auto-registers the AP. Tokens are staked by the AP owner and provider to receive rewards. The AP owner and the provider are rewarded from the sponsor locked tokens, by the blockchain platform, based on receiving periodically by the blockchain a keep alive state of the AP from the provider through the radius server, and data usage of the AP from the provider through the radius server, and from the connected device from the provider.

If an Application Data Sheet (ADS) has been filed for this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Pat. Application No. 621707,177 filed on Oct. 24, 2017.

### BACKGROUND

The present invention relates to a computing environment, and more particularly providing connectivity services utilizing blockchain technology.

### SUMMARY

According to one embodiment of the invention, there is a method that includes a processor and a local storage device accessible by the processor to dynamically reward an Access Point (AP) for connectivity services utilizing a blockchain platform. The blockchain platform receives an AP registration request for an AP. The registration request includes an owner ID for an AP owner registered on the blockchain platform and an AP serial number. After receiving the AP registration request by the blockchain, assigning an AP ID, registering the AP ID with a randomly selecting provider, and recording the AP ID and the registering of the AP ID. The radius server registers the AP based on detecting the registering of the AP ID on the blockchain. The AP owner locks tokens for a first period of time to form locked AP owner staked tokens to receive rewards. Sponsor tokens are locked from a plurality of sponsors for a second period of time to form sponsor locked tokens. Provider tokens are locked from the randomly selected provider associated with the AP for a third period of time to form provider staked tokens to receive rewards. The AP owner and the provider are rewarded from the sponsor locked tokens, by the blockchain platform, based on receiving periodically by the blockchain a keep-alive state of the AP from the provider through the radius server.

According to one embodiment of the invention, there is an information handling system supporting an AP connecting to a blockchain platform via a Radius Server communicating with the AP, an Operator, and a Sponsor to dynamically reward for connectivity services. The information handling system includes one or more processors, a memory coupled to at least one of the processors, a network interface that connects a local device to one or more remote web sites; and a set of computer program instructions stored in the memory and executed by at least one of the processors in order to perform actions including: Installing on the Radius Server a glue service to the AP, Provider, and the Operator. Receiving by the blockchain platform an AP registration request for an AP where the registration request includes an owner ID for an AP owner registered on the blockchain platform and an AP serial number. After receiving the AP registration request by the blockchain, an AP ID is assigned and recording the AP ID and the registering of the AP ID. The radius server registers the AP based on detecting the registering of the AP ID. AP owner tokens are locked from the AP owner for a first period of time to form locked AP owner staked tokens to receive rewards. Sponsor tokens are locked from a plurality of sponsors for a second period of time to form sponsor locked tokens. Provider tokens are locked from the randomly selected provider associated with the AP for a third period of time to form provider staked tokens to receive rewards. The AP owner and the provider are rewarded from the sponsor locked tokens, by the blockchain platform, based on receiving periodically by the blockchain a keep alive state of the AP from the provider through the radius server.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 illustrates an augmented network overview depicting entities used for supporting billing and operations of dynamic internet connectivity services;

FIG. 2 depicts an overview of augmented network operations;

FIG. 3 depicts a flow for augmented network connection;

FIG. 4 depicts a flow for augmented network billing;

FIG. 5 depicts a flow for registering and updating providers in the database;

FIG. 6 depicts a flow for registering and updating operators in the database;

FIG. 7 depicts a flow for registering providers and APs to the blockchain;

FIG. 8 depicts a flow for registering a user in the database;

FIG. 9 depicts a flow for purchasing an AP and connecting to the blockchain network;

FIG. 10 depicts a flow for AP register and keep-alive;

FIG. 11 depicts a flow for changing an AP provider;

FIG. 12 depicts a flow for provider staking and unstaking;

FIG. 13 depicts a flow for processing sponsor reward pools;

FIG. 14 depicts a flow for AP staking and unstaking;

FIG. 15 depicts a flow for processing data markers;

FIG. 16 depicts a flow for redeeming usage markers;

FIG. 17 depicts a flow for session billing; and

FIG. 18 depicts a schematic view of a processing system wherein the methods of this invention may be implemented.

### DETAILED DESCRIPTION

Blockchain technology, sometimes also referred to as “blockchain,” is a particular type of distributed database. Blockchains can theoretically be used to store any type of data or content, but are particularly well-suited to environments in which transparency, anonymity, and verifiability are important considerations. Examples include financial projects, such as cryptocurrencies, auctions, capital management, barter economies, insurance lotteries, and equity crowd sourcing.

A blockchain, originally block chain, is a growing list of records, called blocks, that are linked using cryptography. Each block contains a cryptographic hash of the previous block, a timestamp, and transaction data (generally represented as a Merkle tree). The Merkle tree is a hash-based data structure that is a generalization of the hash list. It is a tree structure in which each leaf node is a hash of a block of data, and each non-leaf node is a hash of its children. Typically, Merkle trees have a branching factor of 2, meaning that each node has up to 2 children.

By design, a blockchain is resistant to modification of its data. This is because once recorded, the data in any given block cannot be altered retroactively without alteration of all subsequent blocks. For use as a distributed ledger, a blockchain is typically managed by a peer-to-peer network collectively adhering to a protocol for inter-node communication and validating new blocks. Although blockchain records are not unalterable, blockchains may be considered secure by design and exemplify a distributed computing system with high Byzantine fault tolerance. A Byzantine fault is a condition of a computer system, particularly distributed computing systems, where components may fail and there is imperfect information on whether a component has failed. The blockchain has been described as “an open, distributed ledger that can record transactions between two parties efficiently and in a verifiable and permanent way. ”

The technology is perhaps most easily understood through a simple and familiar example, such as “Bitcoin,” a cryptocurrency. A cryptocurrency is not entirely dissimilar from conventional currencies and, like a traditional currency, is essentially a medium of exchange. Traditional currencies are represented by a physical object paper currency or minted coins, for example-which is “spent” by physically delivering it in the proper denominations to a recipient in exchange for a good or service.

However, for long-distance transactions, such as buying goods or services over the Internet, direct physical delivery is not feasible. Instead, the currency would have to be mailed to the recipient. However, this carries a very high risk of fraud. The recipient may simply keep the money and not deliver the purchased good or service, leaving the buyer without recourse. Instead, on-line transactions are typically carried out using electronic payment systems in which the transaction is processed, validated, and mediated by a trusted third party. This third party may be a bank, as in the case of a debit or credit card, or a third-party service functioning as an escrow agent, such as PayPal. Crypto currencies operate on this same principle, except that instead of using a financial institution or other third party to facilitate the transaction, the transaction is verified through a consensus reached via cryptographic proof.

Internet is a global computer network providing a variety of information and communication facilities, comprising interconnected networks using standardized communication protocols. Internet is not owned by a single entity and it operates without a central governing body. The same principles of distributed governance were applied to digital currencies by providing ability to perform digital transactions that existed without support from any underlying institution. The digital ledger that records the transactions in a chain using a mathematical hierarchy is called a blockchain.

The current blockchain platform and related applications known to the industry fall short in multiple ways. First, there is no separation of roles on the blockchain based on the role of an entity for a given transaction. Each transaction follows a strict chain of rules and is dependent on its preceding transaction. If one transaction fails, all subsequent transactions on the blockchain become unusable. The computing time and built-in delay in any blockchain platform is dependent on the available computing resources of its nodes. In absence of a role model, a single node has several computing intense tasks that are slow to execute. A slow system becomes vulnerable and becomes open to attacks. The current solutions do not allow for client flexibility in developing distributed applications with immutability and finality of transactions on a blockchain platform.

In order to overcome the deficiencies of the prior art, various methodologies are disclosed where an infrastructure is supplied to enable usage of the disclosed methodology. In an embodiment, application programming interfaces (API) are provided to handle the details where examples are available on the 0chain platform. For this disclosure, high level descriptions of the details are discussed which should be adequate for those with ordinary skill in the art to implement solutions. In this disclosure, support for the identified features may be identified as modules in the blockchain platform with embodiments as described herein embedded in the modules.

The following definitions generally apply to this disclosure and should be understood in both the context of client/server computing generally, as well as the environment of a blockchain network. These definitions, and other terms used herein, should also be understood in the context of leading white papers pertaining to the subject matter. These include, but are not necessarily limited to, Bitcoin: A Peer-to-Peer Electronic Cash System (Satoshi Nakamoto 2008). It will be understood by a person of ordinary skill in the art that the precise vocabulary of blockchains is not entirely settled, and although the industry has established a general shared understanding of the meaning of the terms, reasonable variations may exist.

The term “network” generally refers to a voice, data, or other telecommunications network over which computers communicate with each other. The term “server” generally refers to a computer providing a service over a network, and a “client” generally refers to a computer accessing or using a service provided by a server over a network. The terms “server” and “client” may refer to hardware, software, and/or a combination of hardware and software, depending on context. The terms “server” and “client” may refer to endpoints of a network communication or network connection, including but not necessarily limited to a network socket connection. A “server” may comprise a plurality of software and/or hardware servers delivering a service or set of services. The term “host” may, in noun form, refer to an endpoint of a network communication or network (e.g., “a remote host”), or may, in verb form, refer to a server providing a service over a network (“hosts a website”), or an access point (AP) for a service over a network. It should be noted that the term “blockchain network” as used herein usually means the collection of nodes interacting via a particular blockchain protocol and ruleset. Network nodes are the physical pieces that make up a network. They usually include any device that both receives and then communicates information. But they might receive and store the data, relay the information elsewhere, or create and send data instead.

The term “asset” means anything that can be owned or controlled to produce value.

The term “asymmetric key encryption,” also known as “public key encryption,” “public key cryptography,” and “asymmetric cryptography,” means a cryptographic system that uses pairs of mathematically related keys, one public and one private, to authenticate messages. The “private key” is kept secret by the sending of a message or document and used to encrypt the message or document. The “public key” is shared with the public and can be used to decrypt the message or document.

The term “ledger” means the append-only records stored in a blockchain. The records are immutable and may hold any type of information, including financial records and software instructions.

The term “blockchain” means a distributed database system comprising a continuously growing list of ordered records (“blocks”) shared across a network. In a typical embodiment, the blockchain functions as a shared transaction ledger.

The term “transaction” means an asset transfer onto or off of the ledger represented by the blockchain, or a logically equivalent addition to or deletion from the ledger.

The term “blockchain network” means the collection of nodes interacting via a particular blockchain protocol and rule set.

The term “nonce” means an arbitrary number or other data used once and only once in a cryptographic operation. A nonce is often, but not necessarily, a random or pseudorandom number. In some embodiments, a nonce will be chosen to be an incrementing number or time stamp which is used to prevent replay attacks.

The term “block” means a record in a continuously growing list of ordered records that comprise a blockchain. In an embodiment, a block comprises a collection of confirmed and validated transactions, plus a nonce.

The term “hash” means a cryptographic algorithm to produce a unique or effectively unique value, properly known as a “digest” but sometimes informally referred to itself as a “hash,” usually from an arbitrary, variable-sized input. Hashes are repeatable and unidirectional, meaning the algorithm always produces the same digest from the same input, but the original input cannot be determined from the digest. A change to even one byte of the input generally results in a very different digest, obscuring the relationship between the original content and the digest. SHA256 (secure hash algorithm) is an example of a widely used hash.

The term “mining” means the process by which new transactions to add to the blockchain are verified by solving a cryptographic puzzle. In a proof-of-work blockchain network, mining involves collecting transactions reported to the blockchain network into a “block,” adding a nonce to the block, then hashing the block. If the resulting digest complies with the verification condition for the blockchain system (i.e., difficulty), then the block is the next block in the blockchain.

The term “miner” refers to a computing system that processes transactions. Miners may process transactions by combining requests into blocks. In embodiments, a miner has a limited time, for example, 15-50 milliseconds, to produce a block. Not all miners generate blocks. Miners that generate blocks are called “generators.” Miners may be ranked and chosen to perform transactions based on their ranking. Some limited number of miners may be chosen to perform validation. All miners must be registered on the blockchain. The mining process involves identifying a block that, when hashed twice with SHA256 yields a number smaller than the given difficulty target. While the average work required increases in inverse proportion to the difficulty target, a hash can always be verified by executing a single round of double SHA-256. For the bitcoin timestamp network, a valid proof-of-work is found by incrementing a nonce until a value is found that gives the block’s hash the required number of leading zero bits. Once the hashing has produced a valid result, the block cannot be changed without redoing the work. As later blocks are chained after it, the work to change the block would include redoing the work for each subsequent block. Majority consensus is represented by the longest chain, which required the greatest amount of effort to produce. If a majority of computing power is controlled by honest nodes, the honest chain will grow fastest and outpace any competing chains. To modify a past block, an attacker would have to redo the proof-of-work of that block and all blocks after it and then surpass the work of the honest nodes. The probability of a slower attacker catching up diminishes exponentially as subsequent blocks are added.

Messages representing generated blocks are sent to all miners by identifying the block with a block hash, transaction hash, and a signature of the minor producing the block. The miners receiving the messages replay the transactions for the block and sign an authentication message. If there are enough miners authenticating the block, consensus ticket it signed. In some embodiments a ⅔ +1 agreement or 67% agreement is needed to generate the consensus ticket.

The term “sharding” is a technique in blockchain that seeks to achieve scalability within a blockchain network. The process of sharding seeks to split a blockchain network into separate shards, that contain their own data, separate from other shards.

The term “sharder” refers to a computing system that that keeps tracks of its blockchain history. They are a single source of truth regarding any given transaction.

The term “transaction fee” means a fee imposed on some transactions in a blockchain network. The amount of the transaction fee is awarded to the miner who successfully mines the next block containing that transaction.

The term “wallet” means a computer file or software of a user that allows a user of a blockchain network to store and spend cryptocurrency by submitting transactions to the blockchain network. A wallet is usually itself protected by cryptography via a private key. While there are means to enable shared smart contracts, a wallet is typically assigned to a single person or entity. For an entity hosting a smart wallet, there may be more than one person who has the access rights to make decisions of spending or buying on that smart wallet. In such a situation, the entity smart wallet authentication system is vulnerable if passwords are shared by two or more people. Such a vulnerability could also exist for a smart wallet associated with a household that has two or more members with access privileges.

The term “consensus” refers to a computational agreement among nodes in a blockchain network as to the content and order of blocks in the blockchain.

The term “digital signature” means a mathematically-based system for demonstrating the authenticity of a message or document by ensuring that it was sent from the identified sender and not tampered with by an intermediary. Blockchains generally use asymmetric key encryption to implement digital signatures.

The term “cryptocurrency” (or “crypto”) is a digital currency that can be used to buy goods and services, but uses an online ledger with strong cryptography to secure online transactions. Much of the interest in these unregulated currencies is to trade for profit, with speculators at times driving prices skyward. There are currently many different types of cryptocurrencies offered by many different blockchain implementations. The usage of any given cryptocurrency may be represented herein as “tokens.”

The terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

The term “database” means a computer-accessible, organized collection of data, which may be referred to as “content” in this document. Databases have been used for decades to format, store, access, organize, and search data. Traditionally, databases were stored on a single storage medium controlled by a single computer processor, such as a fixed disk or disk array. However, databases may also be organized in a “distributed” fashion, wherein the database is stored on a plurality of storage devices, not all of which are necessarily operated by a common processor. Instead, distributed databases may be stored in multiple component parts, in whole or part, dispersed across a network of interconnected computers. “difficulty” means proof-of-work mining, or the expected total computational effort necessary to verify the next block in a blockchain. Difficulty is generally determined by the verification rules of the blockchain and may be adjusted over time to cause the blockchain to grow (e.g., new blocks to be verified and added) at a desired rate. For example, in the Bitcoin blockchain network, the difficulty adjusts to maintain a block verification time of about ten minutes across the blockchain network.

It will be understood by one of ordinary skill in the art that common parlance in the computing industry refers to a “user” accessing a “site.” This usage is intended to represent technical access to an online server by a user via a user computer. That is, the reference to a “user” accessing a “server” refers to the user manipulating or otherwise causing client software to communicate over a telecommunications network with server software. This also typically means that the user’s client software is running on a client computer system and accessing the server computer system remotely. Although it is possible that a user may directly access and use the server via the server hardware, and without use of a client system, this is not the typical use case in a client/server architecture.

Staking Tokens. A service provider can be required to stake tokens as part of its service guarantee. This process is similar to locking tokens: the principal is locked in a pool payable to the service provider, and the service provider immediately receives the interest for the locked tokens.

A key difference, however, is that the smart contract permits (some portion of) the staked tokens to be seized if the terms of service are not met. The terms and conditions of this smart contract can be specific to the service provided.

An important property of the disclosed blockchain design is that honest service providers do not have an economic disincentive to stake their tokens. They receive the interest on their staked tokens just as if the tokens had been locked, and earn additional tokens for providing their service.

The systems and methods of a blockchain for transaction rewards on token locking allows a client to engage in transactions without spending the originally owned tokens. The blockchain smart contract-controlled system provides a pool mechanism to lock tokens for a period of time that earn interest. Client may then freely spend the interest tokens without spending their owned tokens.

Service providers including miners, blobbers and sharders engage in a transaction by their free will based on evaluation of rewards and the cost of engaging in servicing that transaction. Sharders are long-term service providers who get rewarded a percentage of tokens from the mining pool and not necessarily with each transaction. Such a framework allows for long-term or community-based services as well.

Interest Payment Models. Our design pays interest immediately upon locking tokens, known as a prepay model. However, different payment models can be built with this design and the notion of pools. Post pay is an alternate method. The owner of tokens might wish to delay the reward to a service provider until once the service has been provided. To achieve this goal, the owner locks tokens and gives the interest to a pool where the smart contract would hold the funds until after the period had elapsed.

Ongoing payment is another alternate method. The client and provider might negotiate terms to pay the reward to the service provider over a period of time. In this model, the reward is set aside in a pool as soon as the client’s tokens are locked. The smart contract allows the service provider to draw a pro-rated amount of the funds until all of the funds have been spent

The term “smart contracts” means computer programs executed by a computer ‘system that facilitate, verify, or enforce the negotiation and performance of an agreement using computer language rather than legal terminology. Smart contracts may be verified and executed on virtual computer systems distributed across a blockchain.

The systems and methods described herein enable a user in a reward- or points-based system implemented via a blockchain network, to purchase a content according to terms of a smart contract. Users can receive, store, and share or send rewards on-demand in exchange for receiving the content. However, the user need not directly use, or even be aware of, the underlying blockchain.

Described herein are systems and methods for an on-line, verifiable payment system that facilitates both manual and automatic payment with transaction costs as small as fractions of a cent. The systems and methods include a financial accounting system that uses smart contract technology and a centralized authority performing blockchain transactions on behalf of multiple independent users, and using bulk processing of transactions to reduce substantially the associated transaction fees, in some cases to fractions of a penny.

One key distinction of the disclosed data storage system from other blockchain storage solutions is the separation of the role of mining from that of providing storage. Computers that provide storage are referred to as blobbers. Blobbers are neither responsible nor required to perform mining. In this manner, the load is lightened on the mining network and enables fast transactions on a lightweight blockchain. As the client and blobber interact, the client generates special signed receipts called markers. These markers act like checks that the blobber can later cash in with the blockchain.

Once the interaction between client and blobber has concluded, the blobber writes an additional transaction to the blockchain, which redeems the markers for tokens, that is, the platform cryptocurrency, and commits the blobber to a Merkle root matching the data stored. The leaves of the Merkle tree must match markers sent from the client, preventing either the client or the blobber from defrauding each other.

A Merkle Patricia Tree (MPT) contains a single root node and several intermediate nodes and leaf nodes. The intermediate nodes can be either full nodes or extension nodes. All these nodes are persisted into an event database.

When a miner or sharder is missing state, either because it is newly added to the active set or because it was temporarily unavailable, it must sync its state with the rest of the mining network. To do this, the miner or miner requests the MPT updates from the other miners.

A consensus algorithm is used that is speculative resulting in a slightly lagging finality. This trade-off achieves high throughput and is similar to how hardware optimizes the instruction pipeline with speculative branch prediction to move as fast as possible. Operating at a very high speed along with speculative branching requires a very sophisticated data structure to manage the state.

Due to speculation, not every computed node is immediately saved to the database It is necessary to operate both persisted nodes as well as in-memory nodes. Further, among the in-memory nodes, it is also necessary to have several parallel paths and following each path can result in different state values.

To deal with all these different types of nodes and to support persistent and in-memory branches of nodes, an abstraction is created called NodeDB. There are three implementations of this abstraction:

1. MemoryDB. This is used to track any insert/update/delete changes into the current computation. The current computation can be the entire block or a single transaction. This is important because we are able to use this to support transaction rollbacks in case of any execution failure of a transaction without rolling back the entire block.

2. LevelDB. This is used to support multiple simultaneous branches. That is, each speculative branch path will have a separate level DB for each block within the branch. A LevelDB is like a linked list with a previous and current member each of which is a NodeDB. Current member is either a MemoryDB or a PersistDB (see below for the later). Previous member can either be a LevelDB pointing go the state as of the prior block that is still in-memory or a PersistDB where any unmodified state beyond this LevelDB is already persisted.

3. PersistDB. This provides an interface to interact with the underlying RocksDB to query and save the MPT nodes. RocksDB is an embedded persistent key-value store for fast storage.

When a block is created (to propose or validate), its state starts with a LevelDB with the prior member pointing to the LevelDB of the prior block and the current member pointing to a brand new MemoryDB. As transactions are executed, the state changes are captured into the MemoryDB.

When a block is finalized, its state is persisted. At this time, the level DB of the finalized block is updated with both the current and prior members pointing to the PersistDB. This design ensures that there is no need to traverse back any further.

The above two ways of managing the block’s database as a block goes through different stages ensures that a) speculative state is accumulated across blocks in the memory b) finalized state is committed to the persistent storage. Older blocks get eventually deleted freeing up memory for the new blocks ensuring a continuous progress of the blockchain without any memory pressure. Since the number of blocks retained in the memory at any given time has some upper bound, the memory requirement depends mostly on the number of transactions per block.

MPT is a versioned data structure. That is, any change to any of the leaves result in changes that get propagated all the way up to the root. As a result, as the blockchain progresses, nodes that are no longer used quickly get accumulated. As these are persisted, the database grows over time and will have a severe impact on the performance.

To deal with this problem, a state pruning mechanism is run in the background. Periodically the state is pruned getting rid of unused MPT nodes. This is done following an algorithm similar to mark and sweep that is used for garbage collection. Each leaf node has an origin field which indicates the block Round when that node was introduced. During the “mark” phase, the entire MPT is traversed from the root (as of a given block in the past to have sufficient buffer) and all reachable nodes are updated with an UpdatedVersion indicating the round of the root. Any node that is still reachable from a given root should be retained. During the “sweep” phase, all nodes within the persist DB are traversed and any node whose UpdatedVersion is less than the root version being pruned is deleted.

It should be noted that when traversing the MPT from the root, it is possible to discover any missing nodes, which indicates that the state is not fully available; these nodes are synced from other miners/sharders. There are times when the prior state is not available. This can happen due to a) a miner joining as part of a view change b) temporary network outage c) miner going down due to crash, scheduled upgrade and so on. The disclosed blockchain has a robust way to cope with such incomplete state. The disclosed blockchain progresses in an optimistic manner without waiting for the entire state DB to be synced.

When a prior state is not available multiple things are tried. First, any missing previous blocks are fetched and their state is computed. This process may be done only up to a certain number of blocks, for example, 10. In that embodiment, for anything beyond, the logic may fall back to requesting delta state change for the block (this delta change can be securely verified). In addition, delta changes are applied optimistically directly on top of what is already present. This allows being able to compute and validate state changes even when the entire state is not available (so long as the changes don’t require retrieving any missing intermediate nodes).

Because of all the above-mentioned sophisticated algorithms, it is important to make sure that the state changes are done properly by dealing with issues like concurrent updates.

In an embodiment, the MPT may be implemented to satisfy requirements of maintaining a global state. For example, a general MPT can contain values on the full nodes. But such a scenario never arises for the global state. Similarly, all paths used to access the MPT are of fixed size for the global state, where the path is the client id (a 64-byte hash). Adoption of the Global state MPT for other use cases should keep this in mind or make changes appropriately to support additional use cases.

The event database may be considered a Global state MPT and is used for fast state access by the blockchain infrastructure for supporting connectivity. Significant state changes are captured in both the event database and the MPT. Various methods may be used to communicate system state changes, for example, formatted messages may be used to communicate state changes or Application Programming Interfaces (APIs) may be used. Lists may be supported by chaining entries or by hashing algorithms. An entry may be added to a list be reading the list, checking if the entry is already in the list and if not already in this, then entry can be adding to the list by chaining a pointer from the last entry in the list to the added entry. The infrastructure supports making a specific call to the event database and following processes to synchronize the state with the MPT. The committed state is valid for the entire blockchain. The MPT provides a record of the events leading to a current state for the blockchain allowing for a replay of the events.

A proxy server acts as a gateway or an intermediary server separating end users from the websites they browse. Using a proxy server helps with controlling internet usage of employees and children, bandwidth savings, improved speeds, privacy benefits, improved security and access to blocked resources by pretending to be at another geographical location. Proxy Re-Encryption is a specialized cryptographic primitive that facilitates a user to share his encrypted file with another user without decrypting the file using a specialized key called Re-Encryption Key (ReKey). Proxy controls which ciphertext of the user needs to be translated or re-encrypted. There are no mechanisms known in the industry that allow flexible user control to proxy re-encryption.

The current model of cloud storage is operated through centralized authorities, which makes such a system susceptible to single point failures and permanent loss of data. Blockchain technology, initially designed as a financial ledger has attracted the attention of researchers in a wide range of applications requiring accountable computing and auditability. Blockchain enabled distributed peer-to-peer cloud storage solutions are steadily replacing its centralized counterpart. A blockchain provides multiple parties to agree upon transactions and contracts in an immutable and auditable way. Decentralized applications (dApp) providers make use of this capability to provide services that are transacted in a publicly verifiable manner. When the service provided by the dApp is not directly from the dApp owner itself but from other third parties, it brings up additional challenges. How would the end user using the dApp trust that the unknown third-party service providers used by the dApp are trust worthy? The current approaches in the industry use a combination of unencrypted to cumbersome ways.

While there are policies in the industry that provide end-to-end user flexibility in securing content from authoring to distribution, none of them offer flexibility in a blockchain setup where there is no single entity on the cloud controlling access. While most systems offer securing content, they may fall short of providing an independently verifiable audit capability. In a world of increasing cybercrime and digital fraud, when something goes wrong, it requires a lot of time and effort to do digital forensic investigation. Blockchains can help reduce this burden by ensuring tamper-proof auditability is part of the enterprise workflows.

The need for connectivity may vary significantly depending on varying user needs. Adjustment of quality and speed of transmission may depend on the data being transferred and the purpose of transfer. For example, a phone or video chat with a friend may have a different priority than a phone call or video chat with a business associated. Similarly, watching a movie for pleasure may have a different standard of quality than watching a “how to” video for performing a service by a technician hired to perform the service. The needs for the speed and availability may vary significantly depending on the context. When a user is traveling the availability or means for connectivity may also vary depending on the location. Typically, providers of mobile connectivity services have APs where they can provide their service for an area of coverage. The quality or speed through an AP may depend on the number of users connected through the AP and the amount of data being transferred through the AP as well as the type of service. An older example is a 3G service with lower data rates than Long Term Evolution (LTE) sometimes referred to as 4G LTE, which is a standard for wireless data transmission that allows for faster transfer than 3G service. Similarly, 5G which is the fifth-generation technology standard for broadband cellular networks supports a faster data transfer rate than the 4G LTE service. Cellular phone companies began deploying 5G service worldwide in 2019, and is the planned successor to the 4G networks and now provides connectivity to most current cellphones

A mobile network operator (MNO), also known as a wireless service provider, wireless carrier, cellular company, or mobile network carrier, is a provider of wireless communications services that owns or controls all the elements necessary to sell and deliver services to an end user, including radio spectrum allocation, wireless network infrastructure, back haul infrastructure, billing, customer care, provisioning computer systems, and marketing and repair organizations.

In addition to obtaining revenue by offering retail services under its own brand, an MNO may also sell access to network services at wholesale rates to mobile virtual network operators (MVNO).

A key defining characteristic of a mobile network operator is that an MNO must own or control access to a radio spectrum license from a regulatory or government entity. A second key defining characteristic of an MNO is that it must own or control the elements of the network infrastructure necessary to provide services to subscribers over the licensed spectrum.

A mobile network operator typically also has the necessary provisioning, billing, and customer care computer systems and the marketing, customer care, and engineering organizations needed to sell, deliver, and bill for services. However, an MNO can outsource any of these systems or functions and still be considered a mobile network operator.

Providers of the connectivity service may have agreements with end users allowing for a fixed amount of data transfer for a fixed rate and additional charges for additional data transfer that exceed the fixed amount of data transfer. However, end users or operators may be willing to pay for the services by using different providers with a pricing for the services needed and actually provided.

Disclosed is flexible approach for allowing a provider to charge a user for connectivity service based on an agreement. Similarly, the user may choose a provider for the connectivity service based on a predicted price of the service. This is especially suited to Citizens Broadband Radio Service (CBRS) which is shared wireless spectrum in the 3.5 GHz band to 3.7 GHz that the Federal Communications Commission has designated for sharing among three tiers of users: incumbent users, priority licensees and generally authorized, which is lightly licensed.

The disclosed protocol allows a provider to provide connectivity to a user though any available means, for example, but not limited to Wi-Fi providers, and cellular networks at the cheapest cost given the user’s required service level. The user registers with an operator of the connectivity services. This is typically supported by some agreement between the user and operator where the user has an account with the operator.

The user comes in contact with an AP for an internet provider. The user may be allowed to connect to the internet via the AP by the internet provider. The internet connectivity support is paid via a terms of service documented in an augmented network smart contract (ANSC). Usage from the user is reported to the Remote Authentication Dial-In User Service (Radius) server which reports the usage to a provider proxy, which is referenced hereafter as a provider server. The provider server is part of the blockchain infrastructure that receives commands from Radius and formats requests to send to ANSC. Radius is a networking protocol that provides centralized authentication, authorization, and accounting (AAA) management for users who connect and use a network service. The user has an account with an augmented network operator. The operator must register with the augmented network smart contract (ANSC) on the blockchain. In this process, the operator creates a pool of tokens that may be used to reward providers for their service [session start, data usage, session stop]. The smart contract may automatically increase charges when more people utilize the AP. Usage reports from a user’s device may be used to prevent cheating.

Augmented network providers offer Wi-Fi or cellular access to support connectivity. The providers must register on the blockchain to specify both their pricing and their service level, collectively referred to as their terms of service. No pre-existing relationship between an operator and a provider is required. In order to join the network, a provider must stake tokens as a guarantee for its quality of service.

Whenever a user enters into the service area of a new provider, the operator looks up the terms of service from the ANSC. If the provider meets the required service level and its pricing is cheaper than that of the provider currently providing connectivity to the user, the operator switches the user to use the new provider instead.

The operator of the connectivity service must register with the augmented network smart contract (ANSC) on the blockchain. The operator creates an account on the blockchain network and populates a wallet with tokens. When the operator registers with the ANSC, the operator locks the tokens for a period of time which allows either the tokens or interest from the locked tokens to be added to a pool of tokens which may be used to reward providers for their service.

The augmented network providers offer Wi-Fi or cellular access supporting internet connectivity to the user. They also register on the blockchain platform to specify both their pricing and their service level, collectively referred to as their terms of service. No pre-existing relationship between an operator and a provider is required. In order to join the network, a provider must stake tokens as a guarantee for its quality of service. The provider may stake tokens by also creating an account on the blockchain platform and populating a wallet with tokens. The provider also locks a number of tokens from their wallet for a period of time and use either commit the locked tokens or interest from the locked tokens to a pool dedicated to the guarantee for its quality of service.

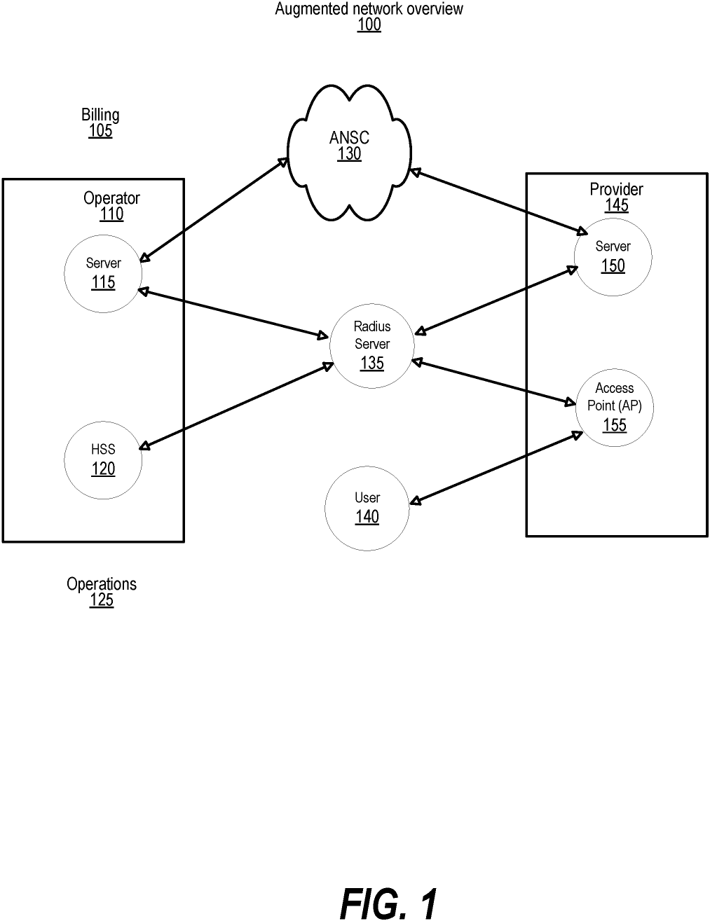

FIGS. 1-4 provide an overview of processing on the augmented network.

FIG. 1 depicts an augmented network overview 100 depicting entities used for supporting billing 105 and operations 125 of dynamic internet connectivity services. In an example embodiment, the entities may comply with a standardized framework, for delivering IP multimedia services, for example, the IP Multimedia Subsystem or IP Multimedia Core Network Subsystem (IMS). The Home Subscriber Server (HSS 120) provides a master user database that supports the IMS network entities that handle the calls/sessions. It contains user profiles, performs authentication and authorization of the user, and can provide information about the physical location of user. The components may be involved in setting up an initial connectivity. An access point (AP) is a server allowing a user device to have connectivity services in a service area via a Remote Authentication Dial in User Service (Radius) Server. An AP sends messages and supports authentication for users on their mobile devices. The AP 155, Provider 145, HSS 120, and User 140 may need to be registered on the blockchain. The provider 145 is a server configured to use the augmented network. The operator 110 is a server configured to use the augmented network The operator server 115 is a server with its own IP address that makes requests on behalf of the operator 110. The provider server 150 is a server with its own IP address that makes requests on behalf of the provider 145. In an embodiment, a user 140 carrying a mobile device comes near an existing AP 155. The AP 155 communicates with a radius server 135 which may be owned by the operator 110. Radius server 135 is configured to communicate with existing APs, HSS 120, provider AP 155, and provider server 150 which acts in behalf of the provider 145, and operator server 115, which acts on behalf of the operator 110. An operator server 115 interacts with ANSC 130 to set up a connectivity session and to terminate the connectivity session. Radius server 135 sits as a bridge between the billing and operational portions of the system. The provider 145 and operator 110 also span these two portions of the system. There may not be any automatic checking between their servers and other components under their control in which case discrepancies between reported usage may occur. In some embodiments, there may be automatic checking between their servers and other components under their control ANSCs.

The operations side begins when a user first connects to a provider’s access point. The blockchain receives from an operator, through the radius server, an authorizing transaction about the user connecting a device through the AP starting a connectivity session with a session id. The AP owner and the provider are rewarded from the sponsor locked tokens, by the blockchain platform, based on receiving by the blockchain data usage messages of the AP from the provider through the radius server. In an embodiment, the provider may also be a sponsor and the radius server may also be a sponsor. The sponsor may be any entity, for example, but not limited to a corporation, a governing jurisdiction, the AP owner, the operator, the blockchain platform, and a utility.

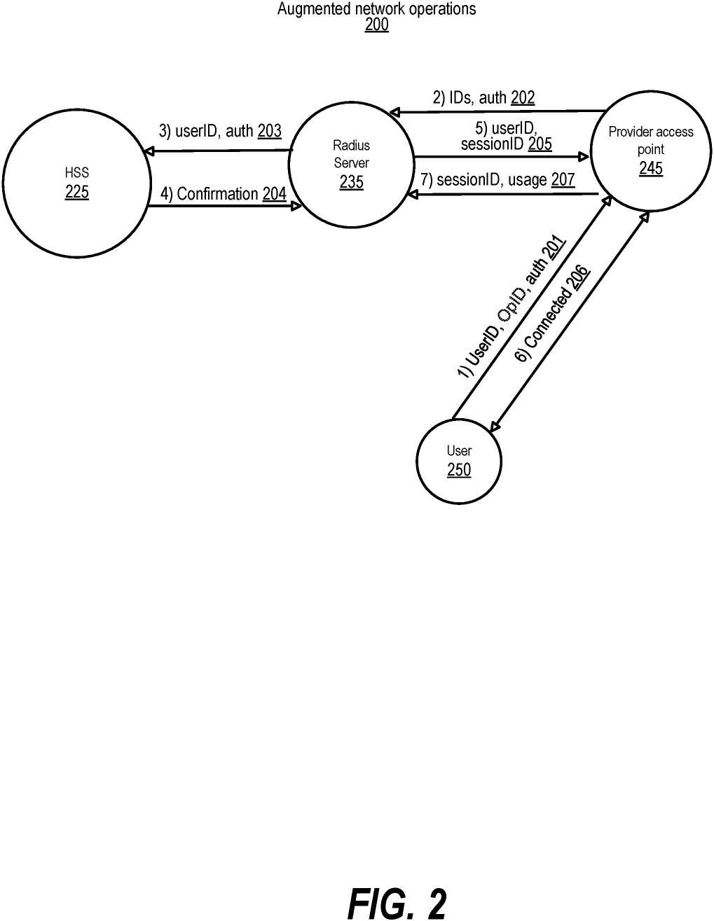

FIG. 2 depicts an overview of an embodiment of augmented network operations 200.

An embodiment of the steps of the process are detailed below:

1. [UserId, OpID, auth 201] The user 250 connects to the provider access point 245, sending authentication details including its user ID (userID), its operator ID (OpID), that is, the operator that the user has registered with or subscribes to, along with any other needed authentication (auth) details to the provider AP 245.

2. [IDs, auth 202] The provider AP 245 connects to radius server 235 and forwards its own provider ID (provID), the ID of the AP (APID), and the auth details 202 to the radius server 235.

3. [userID, auth 203] Radius server 235 sends a message including userID and auth details 203 to the operator’s home subscriber server (HSS) to verify that the user is registered with the operator 110.

4. [Confirmation 204] The HSS 225 sends a confirmation 204 if the user is supported. If HSS 225 responds in the negative, radius server 235 notifies the AP to ignore the user.

5. [userID, sessionID 205] Radius server 235 sends userID to the provider AP 245 and interacts with the operator and provider servers in order to determine whether to use the new AP. If the Operator server gets confirmation of the session from the blockchain, it gets a new sessionID 205 from the blockchain and sends it to the Radius server 235 which relays this information to the provider server, which submits it to the blockchain.

6. [Connected 206] The user is then connected 225 and may then begin using connectivity service with the provider’s AP 245.

7. [Session ID, usage 207] Once the session has completed, the provider AP 245 sends usage data for the session to radius server 235. Radius server 235 then interacts with the operator and provider servers to manage billing.

The billing portion is responsible for coordinating between the operator and provider servers in order to a form an agreement using the augmented network smart contract (ANSC). An operator server and provider server direct radius server’s requests to the appropriate operator and provider respectively. Before billing begins, the operations side has established that the user is a recognized customer of the operator.

To advertise its services, a provider may post a transaction to the ANSC specifying its pricing, its service level, and the date and time when the service will be available. This same mechanism is also used to update pricing information as needed.

The transaction advertising the new service should be posted at least M milliseconds before the specified starting time (as determined by the block time) or the transaction will be rejected. This design ensures that operators do not end up paying a different rate for a session than they had recently read from the blockchain.

Once an operator posts a transaction to the blockchain, it locks in the provider’s pricing at that rate for the duration of the session. However, if an operator attempts to abuse this design, the provider may terminate the session. The user would then begin a new session, and the operator could decide whether to continue at the new pricing, or to use an alternate provider instead.

When a user leaves the service area of a provider, the user will attempt to connect to any other providers within range. The user can then connect to providers following the normal procedure listed in the previous section.

The operator server and the provider server effectively act as agents for the operator and provider, respectively. To minimize the needed trust, these servers ideally would be located with the operator/provider. However, operating the server introduces additional technical burden, and an operator or provider might be willing to trust another entity to manage the server for them. For instance, an operator might have a long-standing business relationship with the radius server. In these cases, the radius server can be operated by the trusted party instead.

The blockchain serves as a public record of the services offered and used. Radius server serves as a partially trusted third party, since it facilitates all interaction between the operator, provider, and their servers. However, the operator and provider are capable of monitoring their servers as well as the blockchain, and would be able to identify any discrepancies. Additionally, the user could also monitor the blockchain for the session ID in order to verify the accuracy of usage data.

To reduce trust further, the servers could be installed on the operator and provider, allowing both the operator and provider to verify their “handshake” on the ANSC, and avoid providing service if that negotiation was unsuccessful.

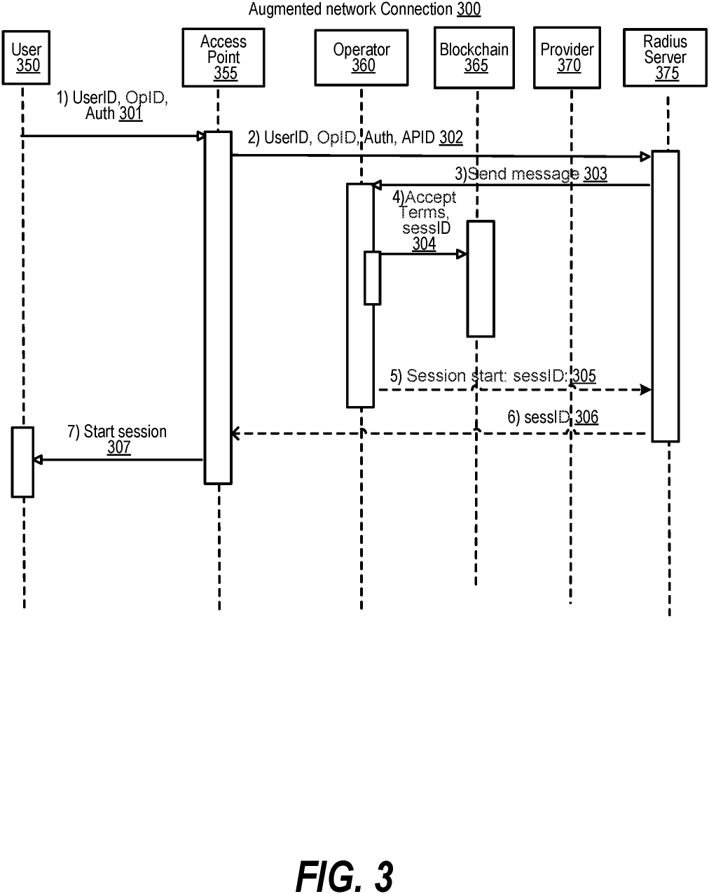

FIG. 3 depicts a flow for an augmented network connection 300. In an embodiment, messages are sent and processing proceeds to support user authentication and starting a session. The following step may occur:

1. [UserId, OpID, auth 301] The user 350 connects to the provider’s access point 310, sending:
Its user ID (userID).
The ID of the operator (OpID) that the user subscribes to.
Any needed authentication data.

2. [UserID, OpID, Auth, APID 302] The provider’s AP 355 connects to radius server 375, sending along the data from step 1, including any authentication data such as its own user ID (userID) and the ID of the AP (APID). These are collectively identified as IDs.

3. [Send message 303] The radius server 315 sends a message to the operator 360. The message contains authentication data which may be verified by the operator’s home subscriber HSS Authentication (Auth) server to verify that the user belongs to the HSS.

4. [Accept terms, sessID 304] If the operator successfully validates the user and the provider’s terms are accepted, an accept terms message including a transaction ID (sessID) 304 is sent to the blockchain 365.

5. [Session start, sessID 305] The HSS confirms that it recognizes the user. (If it responds in the negative, radius server 315 notifies the AP to ignore the user.). The operator 360 notifies the radius server 375 that the session with transaction ID (sessID) has started a session. Without this step, the radius server could defraud the operator, tricking them into paying for a user that was not their customer. However, the operator’s record could detect the problem after the fact.

6. [TxID 306] The radius server 375 notifies the AP 355 of the start of the new transaction with sessID 306.

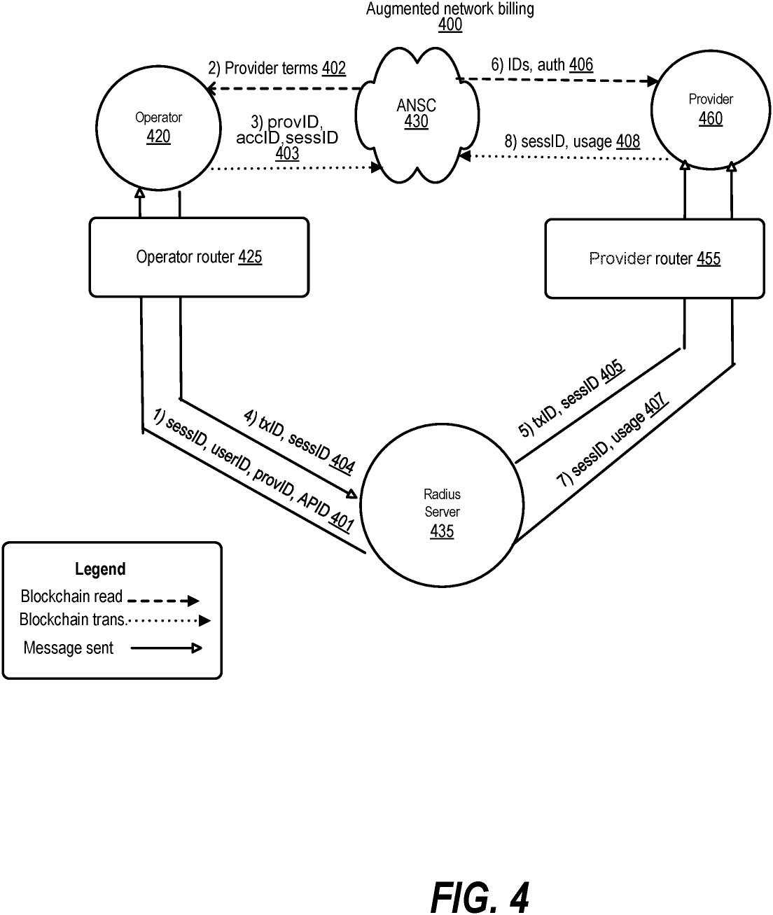

7. [Start session 307] The AP 355 starts session 307 with the user. FIG. 4 provides a schematic flow of a process for augmented network billing 400. The steps of the process are detailed below:

1) [sessionlD, userID, provlD, APID401] Radius server 435 creates a new session by sending the operator 420 through the operator server 425 the session ID (sessID), the user ID (userID), the provider ID (provID), and the AP ID (APID) 401. The operator 420 then queries the ANSC 430 to get the provider terms 402. The ANSC 430 responds with the terms of service including pricing and quality of service information. In some embodiments, the pricing and quality of service may be locked for a period of time. In other embodiments, the pricing and quality of service may not be locked. To minimize the chances of a change to pricing any adjustments to pricing should be advertised in advance on the blockchain. Also note that actual performance by the provider may vary, for example, the terms of service might be better than the user has paid for, but the user’s current session might not meet the terms of service. For example, a silver-level user might not be connected to a provider, and the only available provider offers gold-level service. In this case, it is the operator’s choice is whether to use the new provider or not. There is a slight risk to the operator: a user might deliberately ignore available providers if doing so allows it to receive higher-quality service from another provider.

2) [Provider terms 402] At this point, the operator must decide whether to switch to the new provider based on the specified terms.

3) [ProvID, accID, sessID 403] If the new terms are accepted, the operator server 420 writes a transaction to the ANSC to accept the provider terms 402 and records the transaction ID (txID) as well as the provID, accID, and sessID 403. The transaction to the ANSC locks in the provider pricing and terms of service for the txID.

4) [txID, sessID 404] Next, the operator notifies Radius server that it has accepted the terms for the session, providing both the transaction ID (txID) and the session ID (sessID) 404.

5) [txID, sessID 405] Radius server 435 notifies the appropriate provider 460, through the provider server 455 to begin the new session, specifying the transaction ID (txID) and the session ID (sessID) 405. After connecting to a new provider, an operator might decide to terminate an existing session by notifying radius server 435. Radius server 435 will then notify the provider, who will terminate the session.

6) [txID, sessID 406] The provider server 460 utilizes IDs and auth to verify from the ANSC 430 that the operator server’s transaction has been accepted for this session. At this portion, the operator and provider (via their servers) have established an agreement on the ANSC about the pricing terms. Radius server 435 notifies the provider’s AP, who begins a new session with the user. Once the session has completed, the AP sends the usage data to operator server through the radius server, who initiates the billing:

7) [IDs, auth 407] Radius server 435 forwards the sessID and usage 407 data for the session to the provider 460.

8) [sessID, usage 408] The provider server calls the smart contract with the sessID and usage 408 data. The ANSC 430 then transfer funds from the operator 420 to the provider 460 and AP owner.

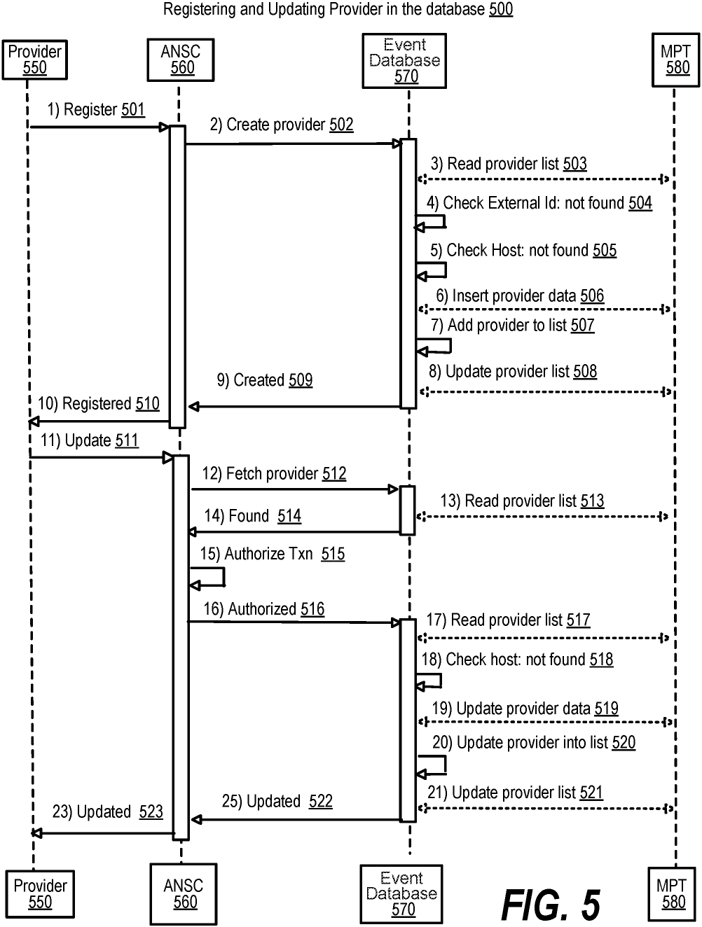

FIGS. 5-17 provide more details of processing on the augmented network.

FIG. 5 depicts a high-level flow of registering and update provider in the database 500. Initially a provider is an entity that has registered as a user on the blockchain, establishing a userID which becomes the provider id (ProvID1). In an embodiment, the following step may occur:

1) [Register 501]: The Provider 550 sends a register 501 message to the ANSC 560 with its userID, for example, Pi.

2) [Create provider 502]: The ANSC 560 send a create provider 502 message to an Application Programming Interface (API), such as, cprov (userid) in the event database 570. The cprov interface executes steps 3) through 8).

3) [Read provider list 503]: A current list of providers is read from a Merkle Patricia Tree (MPT). The MPT provides for a tracking of a current state where updates are propagated to the root. Information from the MPT is also recorded in the event database 570, which may also be characterized as a state machine.

4) [Check External Id: not found 504]: The current list of providers is checked for the provider, where the provider may be known under a different external identification. If found then the registration may have already occurred. If not found, then provider not found in MPT.

5) [Check Host: not found 505]: The event database 570 is also checked for the provider. If the provider is already in the event database 570, then registration may have already occurred. If provider not in event database, then set provider not in event database.

6) [Insert provider data 506]: If the provider not found in MPT, provider added to the MPT. If provider not in event database 570, the provider added to the event database 570.

7) [Add provider to list 507]: If provider not already in the read list, provider added to the list.

8) [Update list 508]: The list is updated in the event database 570.

9) [Created 509]: The cprov interface returns provider successfully created to the ANSC 560.

10)[Registered 510]: The ANSC 560 returns provider registered 510 to the provider 550.

11)[Update 511]: An update provider message is sent for the provider Pj to change one of its APi,j terms, for example, the price to the ANSC 560.

12) [Fetch provider 512]: The ANSC 560 send a fetch provider 502 message to an Application Programming Interface (API), such as, fprov (userid) in the event database 570.

13) [Read provider 513]: A read provider Pj request is sent to the MPT 580, which looks up the provider ID, Pj and returns Pj to the event database 570.

14) [Found 514]: The event database 570 returns the found provider Pj 514 to the ANSC 560.

15) [Authorize Txn 515]: The ANSC 560 indicates the updated provider is authorized to perform transactions (Txn) 515 on the blockchain with new terms of service.

16) [Authorized 516]: The ANSC 560 authorizes the new provider’s terms of service.

17) [Read provider list 517]: Alternatively, a read provider list, rdplist API may be used. In which a read provider Pj request is sent by the event database 570 to the MPT 580, which looks up the provider ID, Pj and returns Pj to the Event database 570.

18) [Check host: not found 518]: If the Provider with the provider ID Pi is not found, then steps 19) through 21) are executed; otherwise, they may be skipped

19) [Update provider data 519]: If necessary, the provider data is updated in the event database 570 and the MPT 580.

20) [Update provider into list 520]: If necessary, the provider ID is added to the provider list in the event database 570

21) [Update provider list 521]: Any updates to the list in the event database provider list is synchronized with the MPT.

22) [Updated 522]: The event database returns a successfully updated return to the ANSC

23) [Updated 523]: The ANSC lets the provider know that the updated terms is ready to be used.

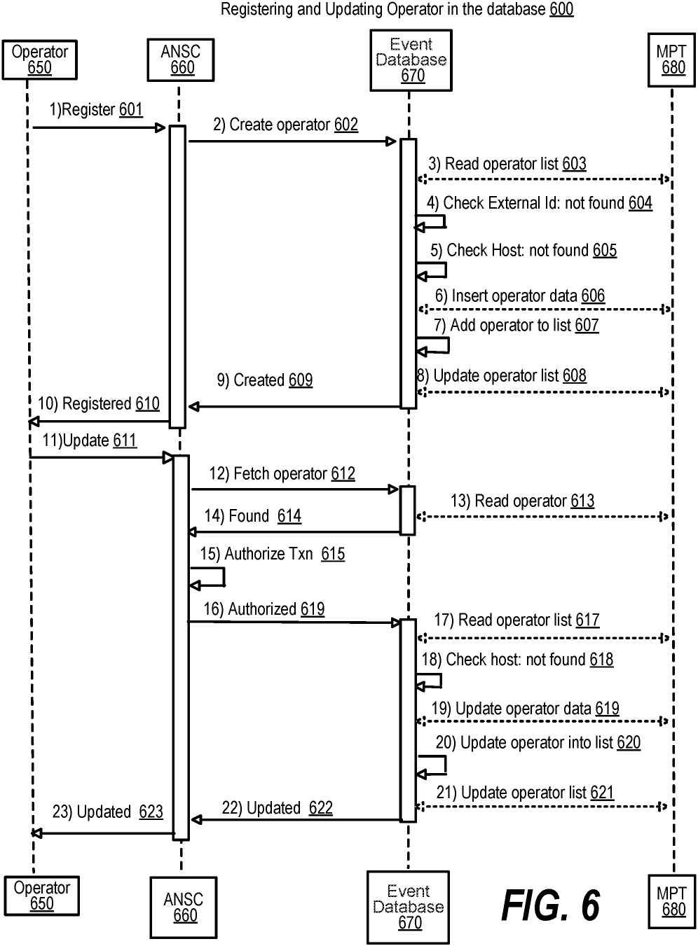

FIG. 6 depicts a high-level flow of registering and updating operator in the database 600. Initially an Operator is an entity that has registered as a user on the blockchain, establishing a userID which becomes the operator id (OPID1). In an embodiment, the following step may occur:

1) [Register 601]: The Operator 650 sends a register 601 message to the ANSC 660 with its userID, for example, Oi.

2) [Create operator 602]: The ANSC 660 send a create operator 602 message to an Application Programming Interface (API), such as, coper (userid) in the event database 670. The coper interface executes steps 3) through 8).

3) [Read operator list 603]: A current list of operators is read from a Merkle Patricia Tree (MPT). The MPT provides for a tracking of a current state where updates are propagated to the root. Information from the MPT is also recorded in the event database 670, which may also be characterized as a state machine.

4) [Check External Id: not found 604]: The current list of operators is checked for the operator, where the operator may be known under a different external identification. If found then the registration may have already occurred. If not found, then operator not found in MPT.

5) [Check Host: not found 605]: The event database 670 is also checked for the operator. If the operator is already in the event database 670, then registration may have already occurred. If operator not in event database, then set operator not in event database.

6) [Insert operator data 606]: If the operator not found in MPT, operator added to the MPT. If operator not in event database 670, the operator added to the event database 670.

7) [Add operator to list 607]: If operator not already in the read list, operator added to the list.

8) [Update list 608]: The list is updated in the event database 670.

9) [Created 609]: The cprov interface returns operator successfully created to the ANSC 660.

10)[Registered 610]: The ANSC 660 returns operator registered 610 to the operator 650.

11)[Update 611]: An update operator message is sent for a operator, for example, Oj to change its criteria for selection to the ANSC 660.

12) [Fetch operator 612]: The ANSC 660 send a fetch operator 602 message to an Application Programming Interface (API), such as, fprov (userid) in the event database 670.

13) [Read operator 613]: A read operator Oj request is sent to the MPT 680, which looks up the operator ID, Oj and returns Oj to the event database 670.

14) [Found 614]: The event database 670 returns the found operator Oj 614 to the ANSC 660.

15) [Authorize Txn 615]: The ANSC 660 indicates the updated operator terms is authorized to perform transactions (Txn) 615 on the blockchain.

16) [Authorized 616]: The ANSC 660 authorizes the new operator’s terms of service.

17) [Read operator list 617]: Alternatively, a read operator list, rdplist API may be used. In which a read operator Oj request is sent by the event database 670 to the MPT 680, which looks up the operator ID, Oj and returns Oj to the Event database 670.

18) [Check host: not found 618]: If the Operator with the operator ID Oi is not found, then steps 19) through 21) are executed; otherwise, they may be skipped

19) [Update operator data 619]: If necessary, the operator data is updated in the event database 670 and the MPT 680.

20) [Update operator into list 620]: If necessary, the operator ID is added to the operator list in the event database 670.

21) [Update operator list 621]: Any updates to the list in the event database operator list is synchronized with the MPT.

22) [Updated 622]: The event database returns a successfully updated return to the ANSC

23) [Updated 623]: The ANSC lets the operator know that the updated Operator ID is ready to be used.

The blockchain system supports multiple connectivity service providers P (P1, P2, ...Pi, ..., Pn) assigned to corresponding access points AP (AP1, AP2, ...APi, ..., APn) with corresponding terms of service S (S1, S2, .., Sj, ..., Sn) wherein the terms of service Si is set by the service provider Pi for the access point APi in an augmented network smart contract (ANSC). Tokens T (T1, T2, Tj, ..., Tn) from sponsors C (C1, C2, Ck, ..., Cm) of the connectivity services may be received by the blockchain platform and used to populate reward pools. When the terms of service Si from an Operator Ok of the connectivity services is accepted, the provider Pi is notified of the acceptance of the terms of service Si. An ANSC state is updated with a user session including a provider id, a session id, and an AP id. When the ANSC receives the session ID, and usage through the provider Pi, the provider Pi and the APi are rewarded based on keep-alive and data usage according to the terms of service Si from AP messages of the APi and user messages from a user device. The keep-alive award may be funded by the blockchain in order to encourage providing capacity. The data usage may be identified by Quality of Service (QoS) messages sent on behalf of the user of the connectivity services. In an embodiment, the QoS messages include a user id, a provider id, a session id, an amount of data transferred, a QoS data, a timestamp, and a signature. The QoS data may include a download speed, an upload speed, and a latency. The QoS message may be sent automatically by a mobile device registered on behalf of the user and the QoS message is sent to a provider. The terms of service Si may be adjusted automatically according to the ANSC based on a number of connections to an AP providing the connectivity service. The provider Pi and the access point APi may be penalized based on the APi staked tokens when an agreed QoS is not met. The terms of service Si may include an identification, a price, a minimum cost, a maximum cost, a download transfer rate, and an upload transfer rate. The sponsor Ck may specify a first portion of the sponsor Ck locked tokens for rewarding the first access point APi and the provider Pi. The sponsor Ck may specify a second portion of the sponsor Ck locked tokens for rewarding a second access point APk and the provider Pk. The sponsor Ck may lock addition tokens to form sponsor Ck additional locked tokens and specify a third portion of the additional locked tokens for rewarding the first access point APi and the provider Pi. The blockchain platform may be a sponsor and generates tokens for paying the AP owner and the provider. In an embodiment, the user registers to the blockchain and the blockchain provides connectivity services to the user without requiring payment from the user and the sponsors provide funding. The AP owner may replace a first randomly selected provider with a second randomly selected provider. In an embodiment, the radius server monitors events or records recorded by the blockchain or the ANSC. The monitoring may be events or state changes to the events database, the MPT, or both the events database and the MPT.

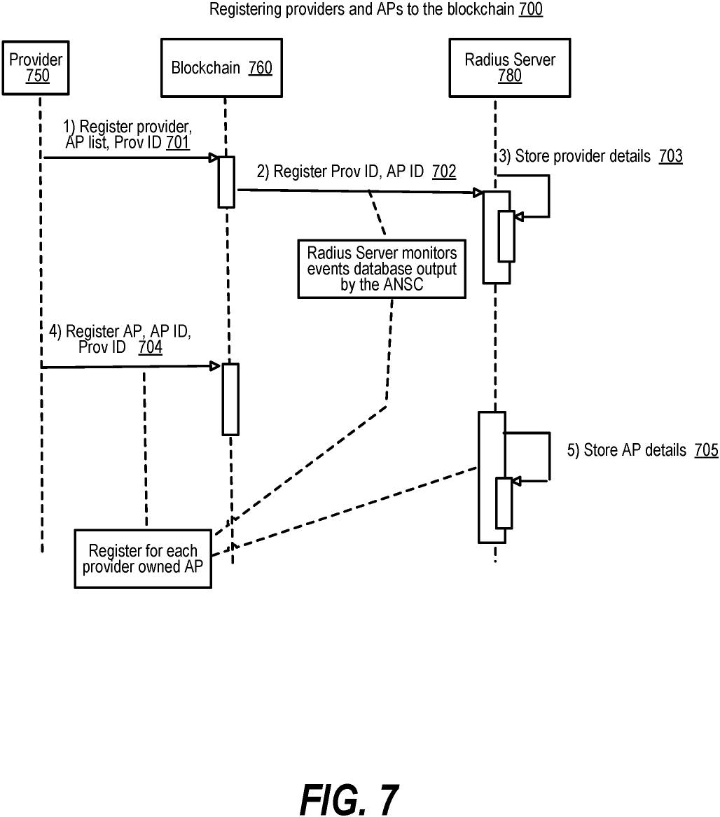

FIG. 7 depicts a high-level flow of process for registering providers and APs 700 to the blockchain 760. The following step occur:

1) [Register provider, AP list, Prov ID 701]: At step 701, a provider 750 sends a message to register itself, identifying itself from its using its provider identification, Prov ID which would normally have been assigned to the provider 750 previously during a sign up to the blockchain 760 establishing an account with wallet or currency privileges. The Prov ID and an AP list is sent to the blockchain 760.

2) [Register Prov ID, AP ID 702]: The blockchain 760 emits an event containing the Prov ID and the AP ID which is monitored by the radius server 780.

3) [Store provider details 703] The radius server 780 stores the provider details on its local machine.

4) [Register AP, AP ID, Prov ID 704] The provider 750 registers each provider owned AP by sending a register AP request to the blockchain 760.

5) [Store AP details 705]: The radius server 780 stores the AP details on its local machine.

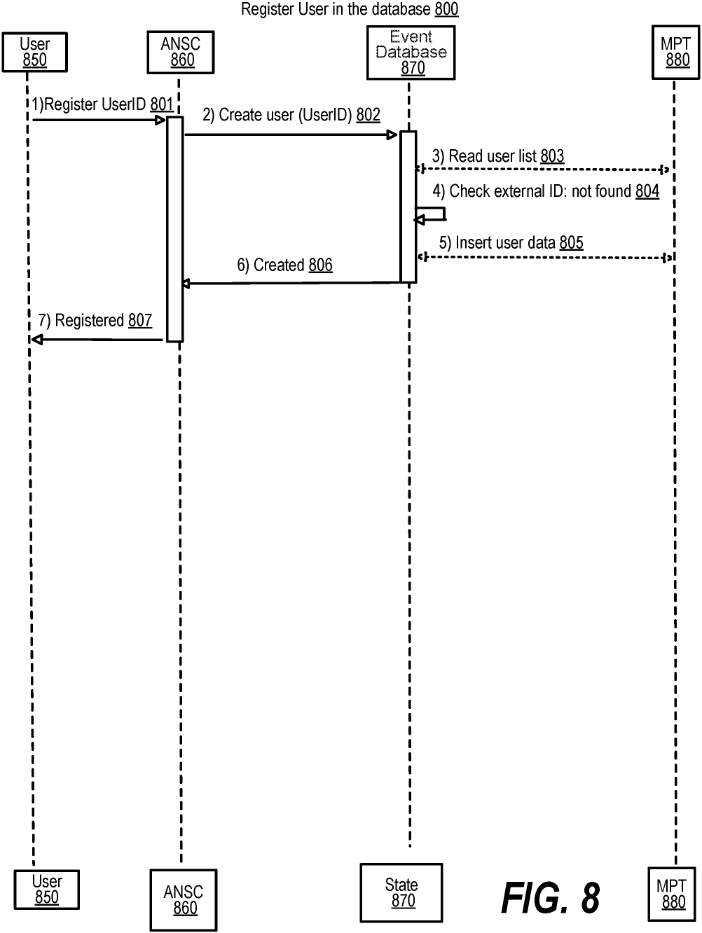

FIG. 8 depicts a high-level flow of registering a user in the database 800. Initially a user is an entity that has registered as a user on the blockchain, establishing a userID which becomes the UserID. In an embodiment, the following step may occur:

1) [Register userID 801]: The user 850 send a register user message as blockchain connectivity user to the ANSC 860.

2) [Create user (userID) 802]: The ANSC 860 issues a create user (UserID) message to the event database 870.

3) [Read user list 803]: The event database 870 requests a read user (UserID) from the user connectivity list to the MPT 860, which returns found or not found.

4) [Check External ID: not found 804]: If the UserId is not found in the event database 870, External ID set to not found,

5) [Insert user data 805]: If External ID set to not found, the event database 870 send the add user to the blockchain connectivity user to the MPT 880.

6) [Created 806]: The event database 870 send a userID created message to the ANSC 860.

7) [Registered 807]: The ANSC 860 emits event that UserID is now registered with the blockchain as a connectivity user.

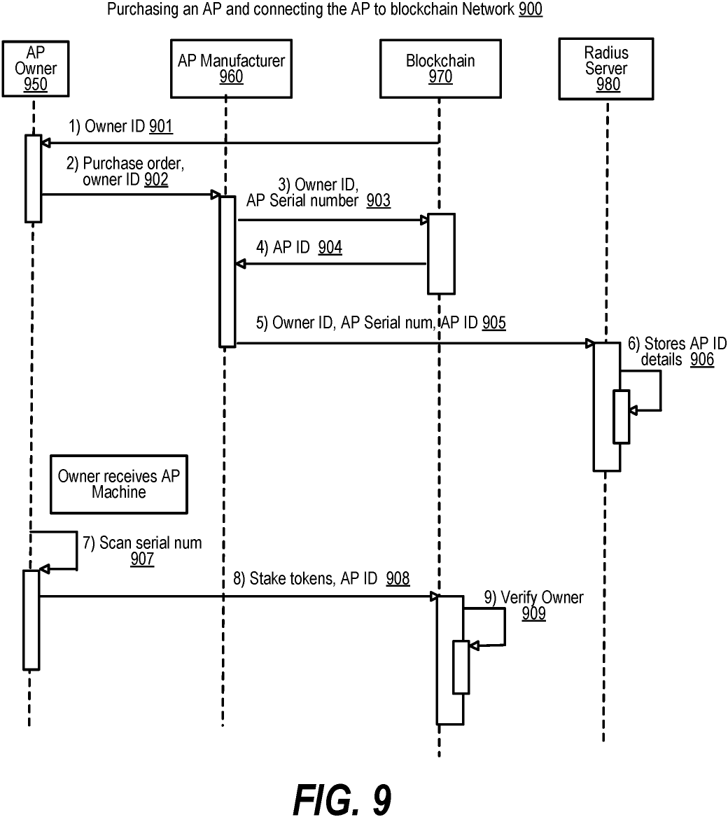

FIG. 9 depicts a high-level flow of process for purchasing an AP and connecting the AP to the blockchain network 900. In an embodiment, the blockchain platform receives an AP registration request for an AP. The registration request includes an owner ID for an AP owner registered on the blockchain platform and an AP serial number. After receiving the AP registration request by the blockchain, the blockchain assigns an AP ID, registers the AP ID with a randomly selected provider, and the radius server auto-registers the AP based on blockchain event emitted during the registration transaction. The following step occur:

1) [Owner ID 901]: The AP owner 950 registers with the blockchain 970 and is assigned or identified a User ID, referenced as owner ID.

2) [Purchase order, owner id 902]: The AP owner 950 notifies the AP manufacturer 960 of the assigned owner ID as part of an AP order purchasing process. In alternative embodiments, support may be fully provided to add the support after the purchase has taken place and before the purchased machine becomes an AP. Support may be supplied via various means, for example, via a Basic Input/Output System (BIOS) update or a hardware interface layer accessed via an application installed on the purchased machine.

3) [Owner ID, AP serial number 903]: The AP manufacturer 960 sends a register AP message to the blockchain 970 indicating the owner ID and the AP serial number. The blockchain 970 completes the registration by assigning an AP ID, which the blockchain ensures is unique though out the blockchain.

4) [AP ID 904]: The AP manufacturer 960 receives the AP ID assigned by the blockchain 970.

5) [Owner ID, AP Serial num, AP ID 905]: The AP manufacturer 960 send a registration message to the radius server 980 to register the Owner ID, AP serial num, and AP ID.

6) [Stores AP ID details 906]: The radius server 980 processes the registration request by storing details of the registration request such as associating the AP ID with the AP serial number and the owner ID.

7) [Scan serial num 907]: When the owner receives the AP machine, the owner may scan the machine to receive the AP serial number or some unique identification associated with the received machine.

8) [Stake tokens, AP ID 908]: The AP owner sends a message to the blockchain 970 registering the AP to participate in connectivity sessions. The AP owner may stake tokens by locking tokens in the AP owner’s blockchain wallet for a period of time, which may be referenced as AP owner staked tokens to receive rewards. The staked token or interest received from the staked tokens may be moved to reward pools as supported by the blockchain platform.

9) [Verify Owner 909]: The blockchain 970 receives the registration request after verifying the owner ID successfully registered the AP to support transactions.

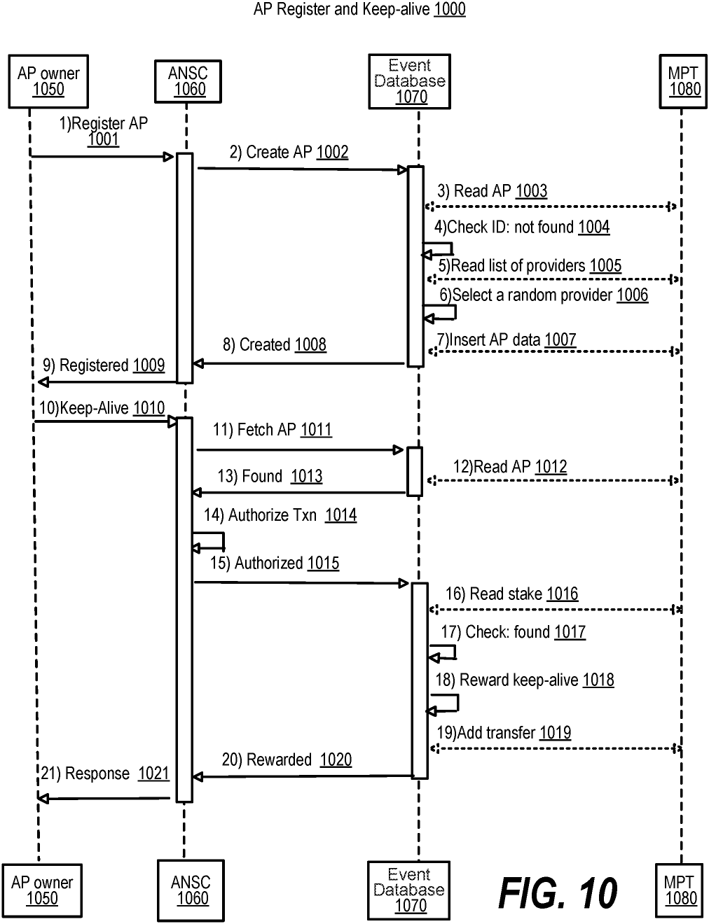

FIG. 10 depicts a high-level flow of processing of AP register and keep-alive 1000. After the AP owner receives the machine and the support for accessing the radius server is enabled for connection to the blockchain. The following step occur:

1) [Register 1001]: The AP owner 1050 sends a registration request message to the ANSC 1060 indicating the AP ID created in step 903.

2) [Create AP 1002]: The ANSC 1060 sends a message to the event database 1070 to determine if the AP ID is registered.

3) [Read AP 1003]: The event database sends a message to the MPT 1080 to see if the AP id is already associated with one or more providers.

4) [Check ID: not found 1004]: If AP ID found and associated with one or more providers, then the process proceeds to step 1008. Otherwise, processing continues as follows.

5) [Read list of providers 1005]: The event database 1070 issues a message to the MPT 1080 to read a list of providers.

6) [Select a random provider 1006]: The event database 1070 selects a random provider from the read list of providers.

7) [Insert AP data 1007]: The event database 1070 sends a message to the MPT 1080 that associates the AP ID with the randomly selected provider.

8) [Created 1008]: The event database 1070 sends a message to the ANSC indicated that the AP has been created.

9) [Registered 1009]: The ANSC 1060 lets the AP owner 1050 that the AP has been registered.

10)[Keep-Alive 1010]: After successfully registering the AP, the AP owner sends a message to the ANSC 1060 indicating that the keep-alive processing is enabled for receiving rewards.

11) [Fetch AP 1011]: The ANSC 1060 issues a fetch AP 1011 message to the event database 1070.

12) [Read AP 1012]: The event database 1070 issues a read AP 1012 request to the MPT 1080, which should return the AP ID to the event database 1070.

13) [Found 1013]: The event database 1070 returns the found AP ID 1013 to the ANSC 1060.

14) [Authorize Txn 1014]: The ANSC 1060 registers an authorize transaction (Txn) status for the AP ID,

15) [Authorized 1015]: The ANSC 1060 sends an AP ID authorized 1015 message to the event database 1070.

16) [Read stake 1016]: The event database 1070 send a read stake request 1016 to the MPT 1080 which should find the stake of the AP ID previously submitted and returns the stake information.

17) [Check host: not found 1017]: The event database 1070 checks that the stake was found 1017.

18) [Reward keep-alive 1018]: The event database 1070 verifies keep-alive reward 1018 is authorized and checks are successful.

19)[Add transfer 1019]: After verifying the keep-alive reward check is successful, the event database requests an add transfer request of the staked keep-alive reward from the AP owner in the MPT 1080 and to the event database 1070. The AP owner and the provider are rewarded from the sponsor locked tokens, by the blockchain platform, based on receiving periodically by the blockchain a keep-alive state of the AP from the provider through the radius server.

20) [Rewarded 1020]: The event database 1070 returns the rewarded stake status to the ANSC 1060.

21) [Response 1021]: The ANSC 1060 returns the keep-alive response to the AP owner 1050.

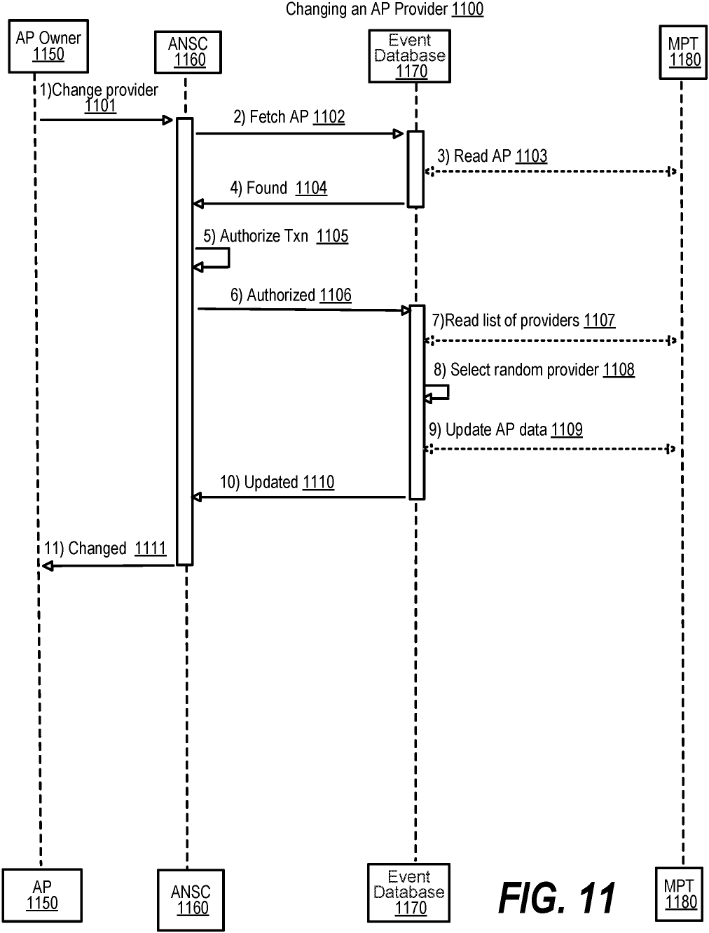

FIG. 11 depicts a high-level flow of changing an AP provider 1100. The changing of provider may be done by the AP owner if the current provider is not responsive. Also, the change may be made to facilitate utilization of sponsor reward pools 1100. The following step occur:

1) [Change provider 1101]: The AP owner 1150 send a change provider 1101 request to the ANSC 1160. This request may be made when current provider is unresponsive (e.g. when server is down).

2) [Fetch AP 1102]: The ANSC sends a fetch or read AP ID to the event database 1170.

3) [Read AP 1103]: The event database 1170 sends a read AP request 1103 to the MPT 1180 which returns the AP ID if found, which would be the normal case.

4) [Found 1103]: The event database 1170 returns that the AP with the AP ID is already in the event database 1170 and the MPT 1180 by returning the found status 1103.

5) [Authorize Txn 1104]: The ANSC authorizes a transaction (Txn) with a txID requesting a change of provider to proceed 1104.

6) [Authorized 1105]: The ANSC 1160 sends a message indicating the Txn is authorized 1105 to proceed to the event database 1170.

7) [Read list of providers 1106]: The event database 1170 sends a read provider list for the AP ID to the MPT 1180 which returns a list of providers 1106.

8) [Select random provider 1107]: The event database 1170 selects a random provider from the returned list of providers 1107.

9) [Update AP data 1108]: Based on the randomly selected provider the data associated with provider is updated for the AP ID 1108 in the MPT 1180 and the event database 1170.

10) [Updated 1109]: The event database 1170 returns the updated provider status to the ANSC 1160.

11) [Changed 1110]: The ANSC 1160 returns the provider changes information 1110 to the AP.

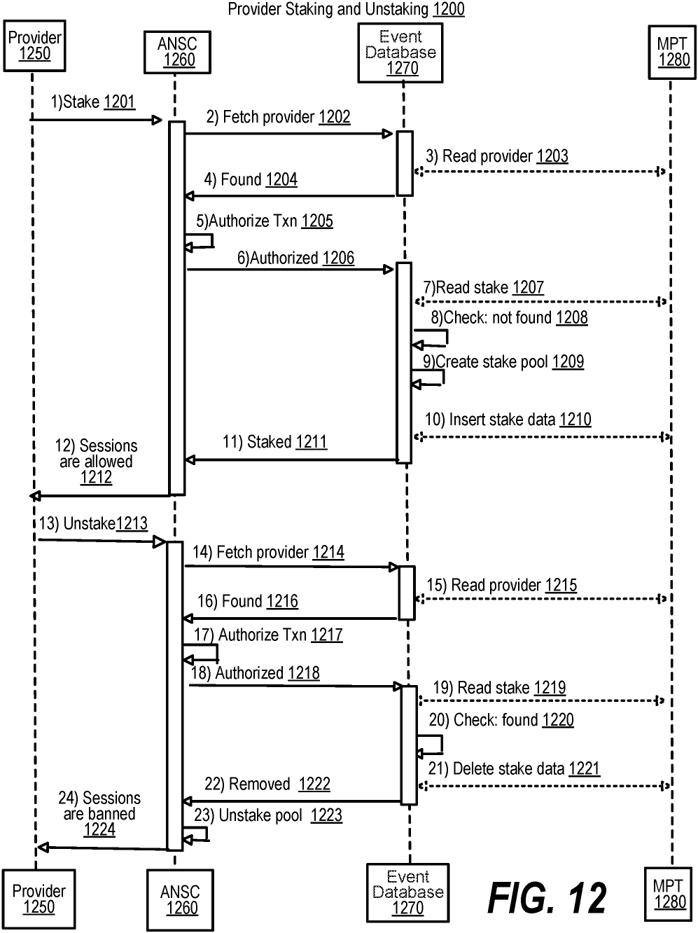

FIG. 12 depicts a high-level flow provider staking and unstaking 1200. The following step occur:

1) [Stake 1201]: The provider 1250 sends a stake 1201 request indicated a quantity of tokens, allocations of the tokens to the AP with an AP ID and conditions for usage of the tokens to the ANSC 1260. Various conditions may be specified, for example, for a specified period of time. The provider may stake tokens by locking tokens in the provider’s blockchain wallet for a period of time, which may be referenced as provider staked tokens to receive rewards. The staked token or interest received from the staked tokens may be moved to reward pools as supported by the blockchain platform. The provider may stake tokens to one or more APs

2) [Fetch provider 1202]: The ANSC 1260 sends a fetch provider 1202 request to the event database 1270.

3) [Read provider 1203]: The event database 1270 sends a read provider request 1203 to the MPT 1280. The MPT 1280 returns the provider information to the event database.

4) [Found 1204]: The event database 1270 returns the found provider information to the ANSC 1260.

5) [Authorize Txn 1205]: The ANSC 1260 authorizes the stake transaction (Txn) 1205. If

6) [Authorized 1206]: The ANSC 1260 sends the stake Txn authorized 1206 message to the event database 1270.

7) [Read stake 1207]: The event database 1270 sends the stake Txn authorized message to the MPT 1280 which would not typically be found and returns the no found status to the event database 1270.

8) [Check: not found 1208]: The event database 1270 check for the not found return 1208.

9) [Create stake pool 1209]: If the stake pool 1209 is not found, the event database creates the stake pool 1209.

10) [Insert stake data 1210]: The event database 1270 inserts stake data into the stake pool 1210 and synchronizes the stake pool information with the MPT 1280.

11) [Staked 1211]: The event database 1270 returns the provider’s stake request successfully staked 1211.

12) [Sessions are allowed 1212]: The ANSC 1260 returns those sessions are allowed 1212 to the provider.

13) [UnStake 1213]: The provider 1250 sends an unstake 1213 request to the ANSC 1260.

14) [Fetch provider 1214]: The ANSC 1260 sends a fetch provider 1214 request to the event database 1270.

15) [Read provider 1215]: The event database 1270 sends a read provider request 1215 to the MPT 1280. The MPT 1280 returns the provider information to the event database.

16) [Found 1216]: The event database 1270 returns the found provider information to the ANSC 1260.

17) [Authorize Txn 1217]: The ANSC 1260 authorizes the unstake transaction (Txn) 1217.

18) [Authorized 1218]: The ANSC 1260 sends the stake Txn authorized 1218 message to the event database 1270.

19) [Read stake 1219]: The event database 1270 sends the unstake Txn authorized message to the MPT 1280 which would typically be found and returns the found status to the event database 1270.

20) [Check: found 1220]: The event database 1270 check for the found return 1220.

21) [Delete stake data 1221]: If the stake pool 1209 is found and the stake data for the provider is found, the event database 1270 deletes the stake data related to the provider stake 1221 and synchronizes the stake pool information with the MPT 1280

22) [Removed 1222]: The event database 1270 returns the remove provider’s stake request successfully unstaked 1222.

23) [Unstake pool 1223]: The ANSC 1250 updates the provider’s stake pool to be unstaked.

24) [Sessions are banned 1224]: The ANSC 1260 returns those sessions are banned 1212 to the provider.

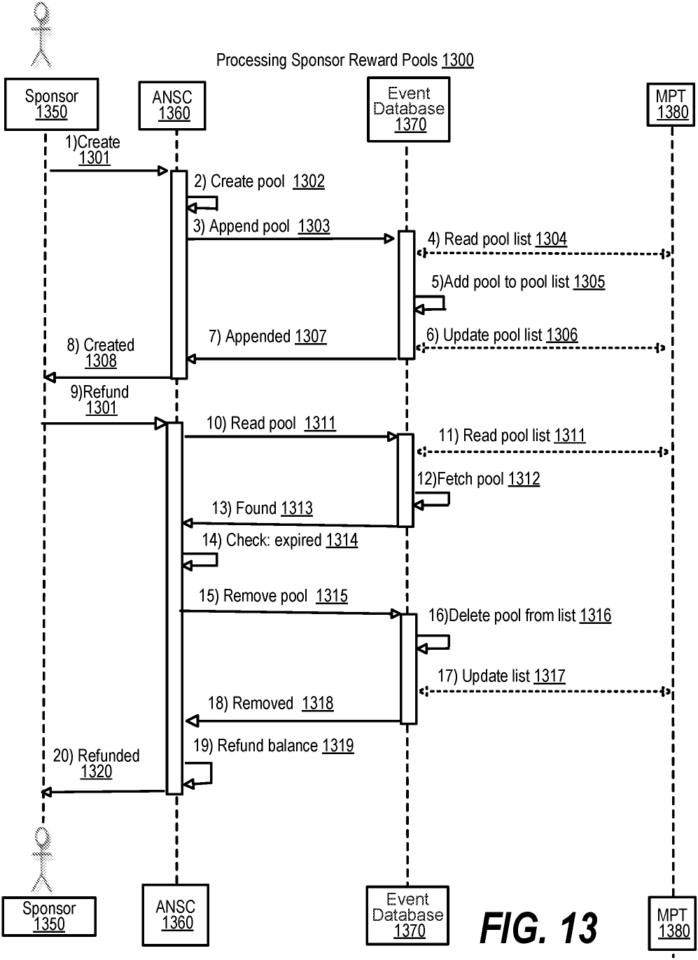

FIG. 13 depicts a high-level flow of processing of sponsor reward pools 1300. The Sponsor may use a command line interface (CLI) to issue commands to the blockchain via the ANSC 1360. Other input support may be supported, such as, a graphical user interface (GUI). The following step occur:

1) [Create 1301]: The sponsor 1350 sends a create reward pool to the ANSC 1360. In an embodiment, the ANSI 1360 supports various parameters, such as, but not limited to a number of tokens to one or more APs, a duration of allocation, a minimum term of service, and the like. The sponsor may stake tokens by locking tokens in the sponsor’s blockchain wallet for a period of time, which may be referenced as sponsor staked tokens to receive rewards. The staked token or interest received from the stake tokens may be added to an existing pool or a new pool may specified. Tokens may be moved to reward pools as supported by the blockchain platform. The sponsor may stake tokens to one or more APs, one or more providers, or a combination of both. Sponsors can choose to add support to an existing pool, for example, one already funded by the blockchain itself or can create a new pool.

2) [Create pool 1302]: If required, one or more new pools are created by the ANSC 1360. In an embodiment, an sponsor may have contributed to a number of different pools with contributions allocated to one or more providers.

3) [Append pool 1303]: The ANSC 1360 sends an append pool message to the event database 1370.

4) [Read pool list 1304]: The event database 1370 sends a read pool list to the MPT 1380 that returns any pool list associated with the read pool list to the event database 1370.

5) [Add pool to list 1305]: The ANSC 1360 merges the sponsor create pool or updates to a previously created pool into the pool list 1305.

6) [Update list 1306]: The event database 1370 synchronizes the updated pool with the MPT 1380.

7) [Appended 1307]: The event database 1370 notifies or returns the status to the ANSC 1360 indicating the new sponsor pool information has been appended to the current pools.

8) [Created 1308]: The ANSC 1360 notifies or returns to the sponsor 1350 that the reward pool is successfully created.

9) [Refund 1309]: A refund request is sent to the ANSC 1360 on behalf of the sponsor 1350.

10) [Read pool 1310]: The ANSC 1360 sends a read pool message to the event database 1370.

11) [Read list 1311]: The event database 1370 sends a read pool list to the MPT 1380 that returns all pool list to the event database 1370.

12) [Fetch pool 1312]: The event database 1370 searches for the pool associated with the refund request.

13) [Found 1313]: When the event database 1370 find the pool associated with the refund request, a found 1313 pool is returned or messaged to the ANSC 1360.

14) [Check: expired 1314]: The ANSC 1360 checks to see if the found pool is expired. If expired then processing continues.

15) [Remove pool 1315]: The ANSC 1360 sends a remove pool request to the event database 1370.

16) [Delete pool from list 1316]: The event database1370 deletes the pool from the list.

17) [Update list 1317]: The event database 1370 deletes the AP from the received and synchronizes the updated list with the MPT 1380.

18) [Removed 1318]: The event database 1370 indicates the requested fund have been removed from the refund pool.

19) [Refund balance 1319]: The ANSC 1360 determines the refund balance and returns the balance to the sponsor 1350.

20) [Refunded 1320]: The ANSC 1360 notifies the sponsor of the returned balance.

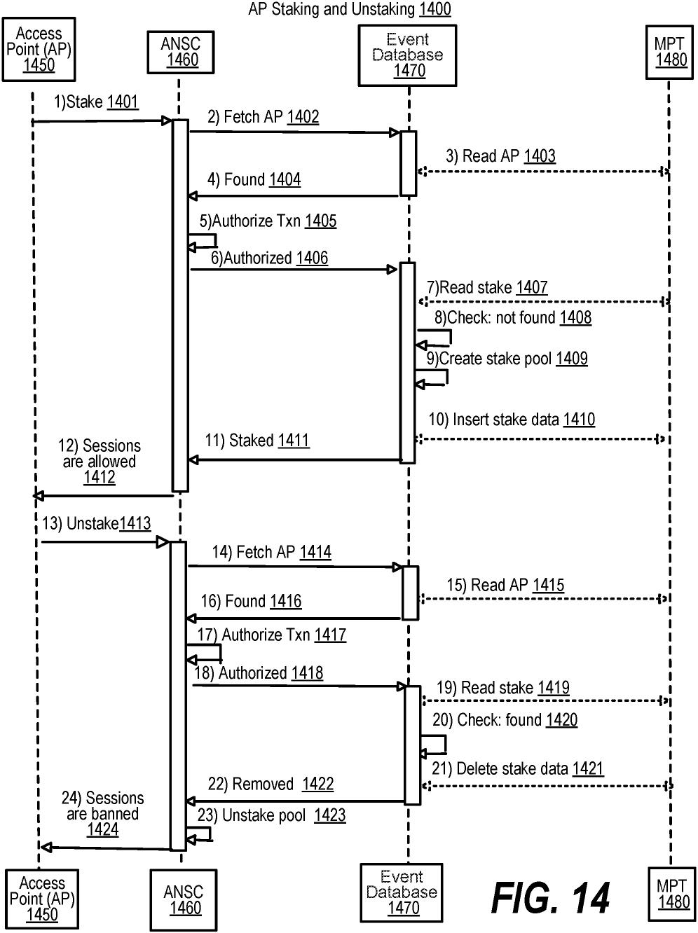

FIG. 14 depicts a high-level flow AP staking and unstaking 1400. The following step occur:

1) [Stake 1401]: The AP 1450 sends a stake 1401 request indicated a quantity of tokens, allocations of the tokens to the AP with an AP ID and conditions for usage of the tokens to the ANSC 1460. Various conditions may be specified, for example, for a specified period of time.

2) [Fetch AP 1402]: The ANSC 1460 sends a fetch AP 1402 request to the event database 1470.

3) [Read AP 1403]: The event database 1470 sends a read AP request 1403 to the MPT 1480. The MPT 1480 returns the AP information to the event database.

4) [Found 1404]: The event database 1470 returns the found AP information to the ANSC 1460.

5) [Authorize Txn 1405]: The ANSC 1460 authorizes the stake transaction (Txn) 1405.

6) [Authorized 1406]: The ANSC 1460 sends the stake Txn authorized 1406 message to the event database 1470.

7) [Read stake 1407]: The event database 1470 sends the stake Txn authorized message to the MPT 1480 which would not typically be found and returns the no found status to the event database 1470.

8) [Check: not found 1408]: The event database 1470 check for the not found return 1408.

9) [Create stake pool 1409]: If the stake pool 1409 is not found, the event database creates the stake pool 1409.

10) [Insert stake data 1410]: The event database 1470 inserts stake data into the stake pool 1410 and synchronizes the stake pool information with the MPT 1480.

11) [Staked 1411]: The event database 1470 returns the AP’s stake request successfully staked 1411.

12) [Sessions are allowed 1412]: The ANSC 1460 returns those sessions are allowed 1412 to the AP.

13) [UnStake 1413]: The AP 1450 sends an unstake 1413 request to the ANSC 1460.

14) [Fetch AP 1414]: The ANSC 1460 sends a fetch AP 1414 request to the event database 1470.

15) [Read AP 1415]: The event database 1470 sends a read AP request 1415 to the MPT 1480. The MPT 1480 returns the AP information to the event database.

16) [Found 1416]: The event database 1470 returns the found AP information to the ANSC 1460.

17) [Authorize Txn 1417]: The ANSC 1460 authorizes the unstake transaction (Txn) 1417.

18) [Authorized 1418]: The ANSC 1460 sends the stake Txn authorized 1418 message to the event database 1470.

19) [Read stake 1419]: The event database 1470 sends the unstake Txn authorized message to the MPT 1480 which would typically be found and returns the found status to the event database 1470.

20) [Check: found 1420]: The event database 1470 check for the found return 1420.

21) [Delete stake data 1421]: If the stake pool 1409 is found and the stake data for the AP is found, the event database 1470 deletes the stake data related to the AP stake 1421 and synchronizes the stake pool information with the MPT 1480

22) [Removed 1422]: The event database 1470 returns the remove AP’s stake request successfully unstaked 1422.

23) [Unstake pool 1423]: The ANSC 1450 updates the AP’s stake pool to be unstaked.

24) [Sessions are banned 1424]: The ANSC 1460 returns those sessions are banned 1412 to the AP.

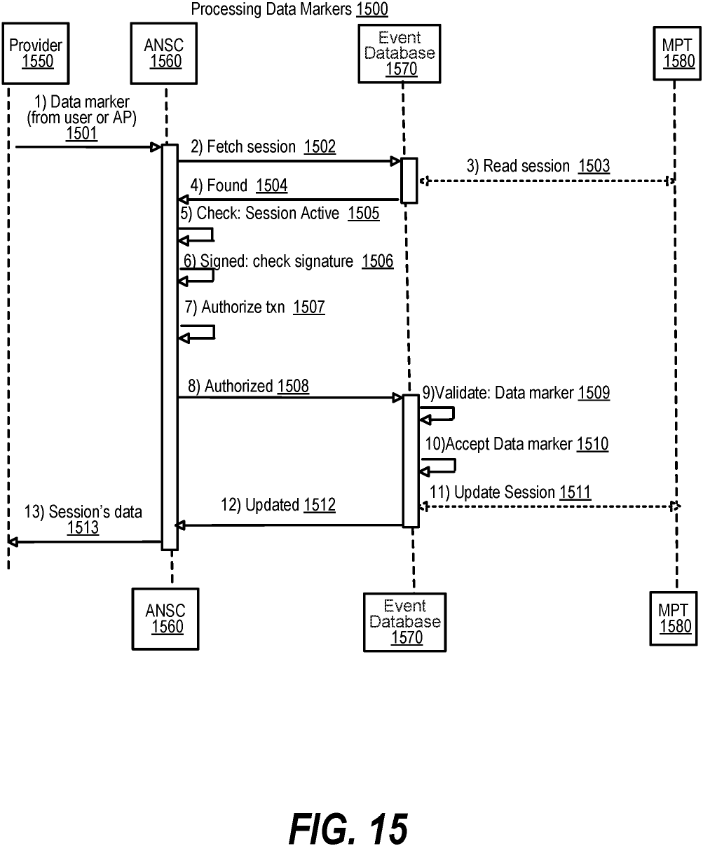

FIG. 15 depicts a high-level flow of processing of data markers 1500. The following step occur:

1) [Data marker (from user or AP) 1501]: A data marker received from a user or an AP is processed by the provider 1550 by sending the data marker to the ANSC 1560.

2) [Fetch session 1502]: The ANSC 1560 retrieves the session ID from the data marker and requests session information from the event database 1570.

3) [Read session 1503]: The event database 1570 requests a read of the session from the MPT 1580 which returns the session information to the event database 1570.

4) [Found 1504]: The event database 1570 returns the session found information to the ANSC 1560.

5) [Check: Session Active 1505]: The ANSC 1560 checks to see if the session is active. If the session is not active, processing terminates to prevent reuse of old markers.

6) [Signed: Check signature 1506]: The ANSC 1560 verifies the signature is valid. If the signature is not valid, processing terminates to prevent payment from a not valid marker.

7) [Authorize Txn 1507]: The ANSC 1560 verifies that the transaction (Txn) associated with the session is valid. If the Txn is not valid, processing terminates to prevent payment from a not valid marker.

8) [Authorized 1508]: If the ANSC 1560 successfully validated the marker, then an authorized message is sent to the event database 1570.

9) [Validate Data marker 1509]: The event database 1570 receives the authorized message and sets the state of the data marker to validated.

10) [Accept Data marker 1510]: The event database 1570 sets the state of the data marker to accepted.

11) [Update Session 1511]: The event database 1570 updates the session with the data marker information and synchronizes the update with the MPT 1580.

12) [Updated 1512]: The event database notifies that ANSC 1560 that the information from the marker has been updated in the system.

13) [Session’s data 1513]: The ANSC 1560 notifies the provider that the session data from the data marker sent by the user or the AP has been processed.

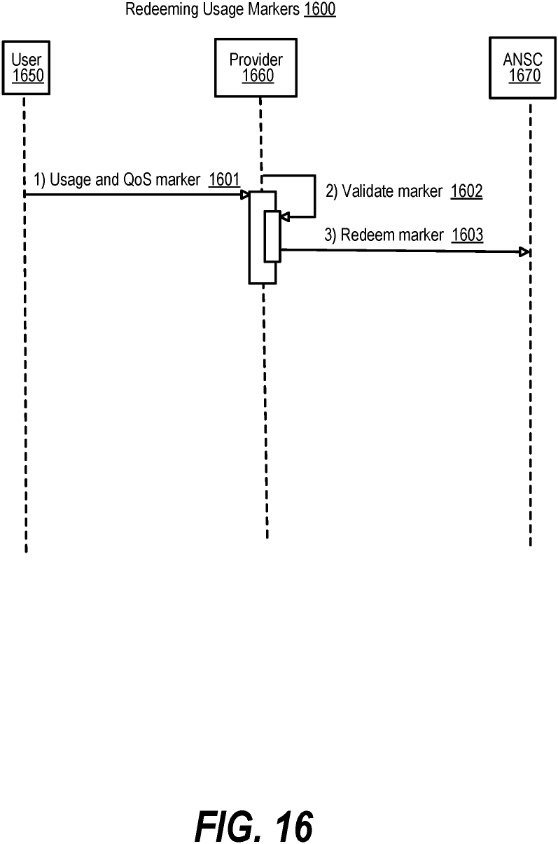

FIG. 16 outlines the process for redeeming usage markers 1600. User based usage markers may be used to prevent cheating. The user usage markers go through the provider and are forwarded to the blockchain. After creating and signing a QoS marker, the following step occur:

1) [Usage and QoS marker 1601] The user 1650 sends usage and QoS marker 1601 to the provider 1660.

2) [Validate marker 1602] The provider 1660 validates marker 1602 by checking the information contained in the marker. If all the fields are valid, and if the server deems the usage information reported in the marker to be reasonably accurate, the provider 1660 successfully validates the marker.

3) [Redeem marker 1603] After successfully validating the marker, the provider 1660 writes a redemption marker 1609 as transaction to the ANSC 1630 in order to redeem the marker 1603 and get paid for the service provided.

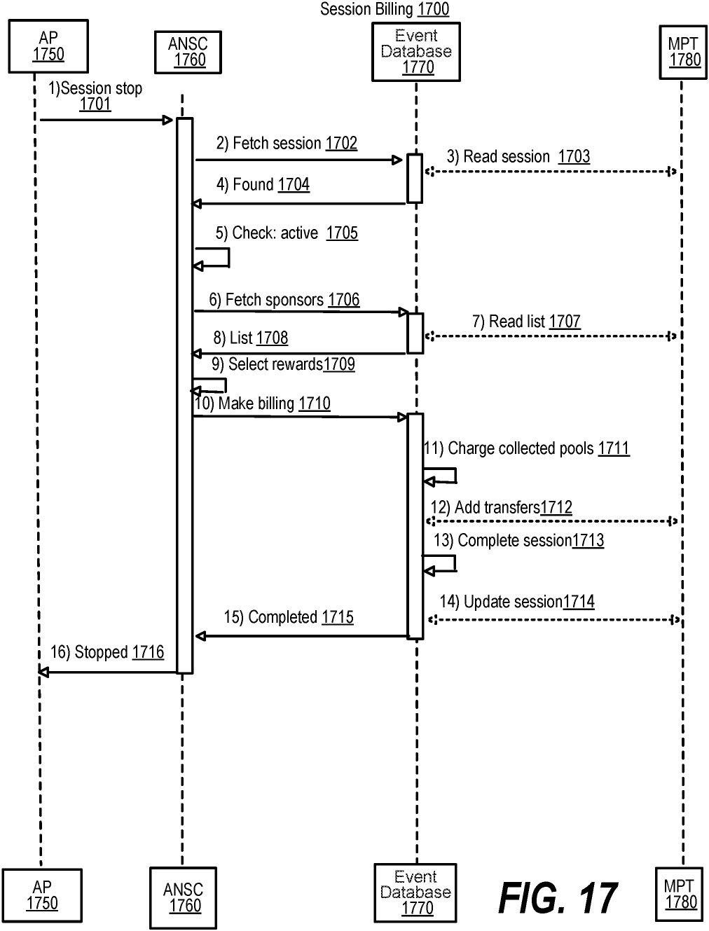

FIG. 17 depicts a high-level flow of session billing 1700. Billing occurs at an end of a session, that is, when the session stop. The following step occur:

1) [Session stop 1701]: When the user’s device has indicated to the AP 1750 that the session is to be stopped, and session billing is to be initiated. The AP 1750 sends a session stop message 1701 indication the session ID to the ANSC 1760.

2) [Fetch session 1702]: The ANSC 1760 sends a fetch session message indicating the session ID to the event database 1770.

3) [Reads session 1703]: The event database 1770 sends a read session message 1703 indicating the session ID to the MPT 1780. The MPT 1780 returns information regarding the session ID to the event database 1770.

4) [Found 1704]: The event database 1770 verifies that the session ID was found. If not found, the billing is terminated.

5) [Check: active 1705]: The event database 1770 verifies that the session is currently active. If not currently active, the billing is terminated.

6) [Fetch sponsors 1706] Then ANSC sends a fetch sponsors message to the the event database 1770.

7) [Read list 1707]: The event database 1770 sends a read list of sponsors for the AP 1750 to the MPT 1780. The MPT 1780 returns the list of sponsors for the AP 1750 to the event database 1770.

8) [List 1708]: The event database 1770 returns the list of sponsors to the ANSC 1780.

9) [Selects rewards 1709]: The ANSC 1780 examines the list of sponsors and the funding available to the AP to determine which funding to use. In an embodiment, a prioritized list of conditions may be used, for example, funding that is about expire may be used first. If no funding is about to expire, funding directed toward the AP may be prioritized ahead of funding for multiple APs.

10)[Make billing 1710]: Once the funding is chosen, billing is prepared by sending a billing request by the ANSC 1780 to the event database 1770.

11) [Charge collected pools 1711]: The event database 1770 selects funds from one or more funding pools to charge.

12)[Add transfers 1712]: The event database 1770 send transfer requests to the MPT 1780 as needed to transfer funds from the selected pools. The MPT 1780 indicates the successful transfers to the event database 1770.

13)[Complete session 1713]: After all transfers are completed, the event database 1770 indicates that the session is completed.

14) [Update session 1714]: The event database 1770 synchronizes the session is completed state with the MPT 1780 by updating the session 1714.

15)[Completed 1715]: The event database 1770 returns the session completed status to the ANSC 1760.

16)[Stopped 1716]: The ANSC 1760 returns the session stopped status to the AP 1750.

Various phases may be used for developing this network. For example, a first phase could be one operator and one provider. Focusing on these pieces individually would facilitate concentrating of the development of the ANSC, the operator and provider server design, and the interaction with radius server. A second phase could be one operator with multiple providers which would introduce multiple proxies and would also require the introduction of the provider proxy router. The third and final phase could be multiple operators and multiple providers which would requires the introduction of a router to manage the interaction of Radius server with the multiple operator proxies.

In an embodiment, there may be multiple radius server operators and users are required to install support for generating signed QoS markers that that they must send to the providers. The providers can redeem these markers on the blockchain platform for payment. These markers may also include quality-of-service statistics for the previous period of usage (that is, since the last marker was redeemed). By redeeming these markers, the provider gives tacit agreement to the statistics reported by the user, and shares a public record of its performance. Should the provider not agree with the statistics, they may choose not to redeem the markers and to terminate the connection with the user. Note that the user sends the first usage marker before receiving service, so the initial usage marker does not contain any useful statistics. Additionally, there will be no statistics for the final period of usage after the last usage marker is received. Alternatively, discrepancies may be detected after the fact.

Quality-of-Service Markers: During operation, the AP responds to the server with information about usage and quality-of service for the session. The QoS markers from the user are included, which the server can attempt to reconcile. If the usage information seems valid (or within acceptable limits), the server redeems the usage markers on the blockchain. To do so, the server writes a transaction to the blockchain with the session ID and usage. If the session is complete, the ANSC transfers tokens from the token pool to the provider based on the usage; any additional tokens are returned to the operator.

In an embodiment, the user periodically writes a QoS marker to pay in arrears for the service it received. A session is divided up into periods, which are defined as the amount of time between QoS markers.

During operation, the AP responds to the server with information about usage and quality-of service for the session. The QoS markers from the user are included, which the server can attempt to reconcile. If the usage information seems valid (or within acceptable limits), the server redeems the usage markers on the blockchain. To do so, the server writes a transaction to the blockchain with the session ID and usage. If the session is complete, the ANSC transfers tokens from the token pool to the provider based on the usage; any additional tokens are returned to the operator.

In an embodiment, user periodically writes a QoS marker to pay in arrears for the service it received. A session is divided up into periods, which are defined as the amount of time between QoS markers.

The QoS markers should include:

1. UserID.

2. Provider ID.

3. Session ID.

4. Amount of data to uploaded/downloaded during the previous period.

5. QoS data for the previous period, including:
a. Download speed
b. Upload speed
c. Latency

6. A timestamp, to ensure freshness.

7. A signature, ensuring the authenticity of all the above fields.

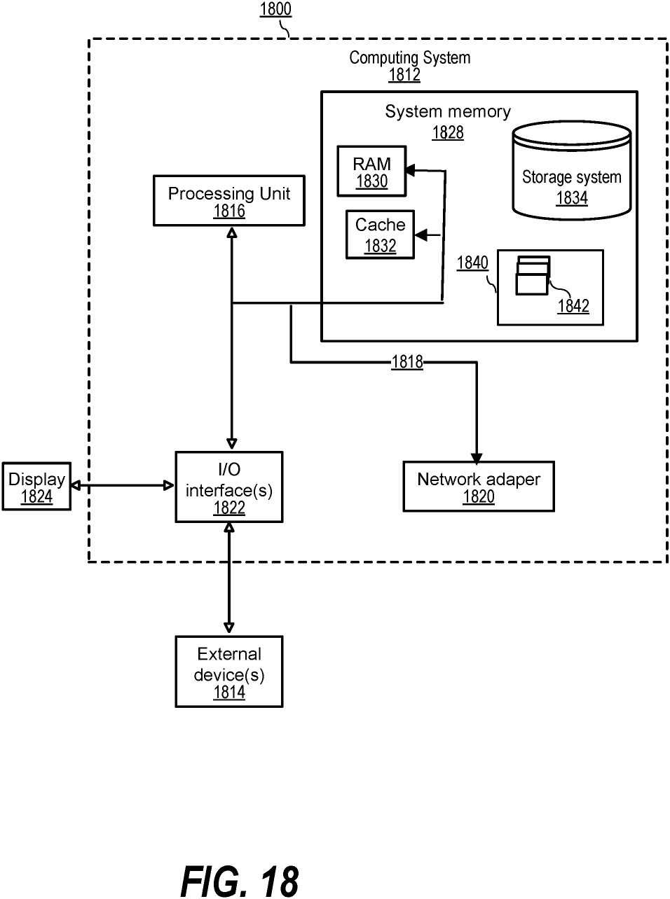

Referring to FIG. 18, a schematic view of a processing system 1800 is shown wherein the methods of this invention may be implemented. The processing system 1800 is only one example of a suitable system and is not intended to suggest any limitation as to the scope of use or functionality of embodiments of the invention described herein. Regardless, the system 1800 can implement and/or performing any of the functionality set forth herein. In the system 1800 there is a computer system 1812, which is operational with numerous other general purpose or special purpose computing system environments or configurations. Examples of well-known computing systems, environments, and/or configurations that may be suitable for use with the computer system 1812 include, but are not limited to, personal computer systems, server computer systems, thin clients, thick clients, handheld or laptop devices, multiprocessor systems, microprocessor-based systems, set top boxes, programmable operator electronics, network PCs, minicomputer systems, mainframe computer systems, and distributed cloud computing environments that include any of the above systems or devices, and the like.

The computer system 1812 may be described in the general context of computer system-executable instructions, such as program modules, being executed by a computer system. Generally, program modules may include routines, programs, objects, components, logic, data structures, and so on that perform tasks or implement abstract data types. The computer system 1812 may be practiced in distributed cloud computing environments where tasks are performed by remote processing devices that are linked through a communications network. In a distributed cloud computing environment, program modules may be in both local and remote computer system storage media including memory storage devices.

As shown in FIG. 18, the computer system 1812 in the system environment 1800 is shown in the form of a general-purpose computing device. The components of the computer system 1812 may include, but are not limited to, a set of one or more processors or processing units 1816, a system memory 1828, and a bus 1818 that couples various system components including the system memory 1828 to the processor 1816.

The bus 1818 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 1812 typically includes a variety of computer system readable media. Such media may be any available media that is accessible by the computer system 1812, and it includes both volatile and non-volatile media, removable and non-removable media.

The system memory 1828 can include computer system readable media in the form of volatile memory, such as random-access memory (RAM) 1830 and/or a cache memory 1832. The computer system 1812 may further include other removable/non-removable, volatile/non-volatile computer system storage media. By way of example only, a storage system 1834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1818 by one or more data media interfaces. As will be further depicted and described below, the system memory 1828 may include at least one program product having a set (e.g., at least one) of program modules 1842 that are configured to carry out the functions of embodiments of the invention.

A program/utility 1840, having the set (at least one) of program modules 1842, may be stored in the system memory 1828 by way of example, and not limitation, as well as an operating system, one or more application programs, other program modules, and program data. Each of the operating systems may have one or more application programs, other program modules, and program data or some combination thereof, and may include an implementation of a networking environment. The program modules 1842 generally carry out the functions and/or methodologies of embodiments of the invention as described herein.

The computer system 1812 may also communicate with a set of one or more external devices 1814 such as a keyboard, a pointing device, a display 1824, a tablet, a digital pen, etc. wherein these one or more devices enable a user to interact with the computer system 1812; and/or any devices (e.g., network card, modem, etc.) that enable the computer system 1812 to communicate with one or more other computing devices. Such communication can occur via Input/Output (I/O) interfaces 1822. These include wireless devices and other devices that may be connected to the computer system 1812, such as, a USB port, which may be used by a tablet device (not shown). Still yet, the computer system 1812 can communicate with one or more networks such as a local area network (LAN), a general wide area network (WAN), and/or a public network (e.g., the Internet) via a network adapter 1820. As depicted, a network adapter 1820 communicates with the other components of the computer system 1812 via the bus 1818. It should be understood that although not shown, other hardware and/or software components could be used in conjunction with the computer system 1812. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals perse, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method that includes a processor and a local storage device accessible by the processor to dynamically reward an Access Point (AP) for connectivity services utilizing a blockchain platform comprising:
receiving, by the blockchain platform, an AP registration request for the AP wherein the AP registration request includes an owner ID for an AP owner registered on the blockchain platform and an AP serial number;
responsive to receiving the AP registration request, by the blockchain platform, assigning an AP ID and registering the AP ID with a randomly selected provider;
recording the AP ID and the registering of the AP ID, by the blockchain platform;
responsive to detecting the recording of the AP ID, by a radius server, registering the AP;
locking AP owner tokens from the AP owner for a first period of time to form locked AP owner staked tokens to receive rewards;
locking sponsor tokens from a plurality of sponsors for a second period of time to form sponsor locked tokens;
locking provider tokens from the randomly selected provider associated with the AP for a third period of time to form provider staked tokens to receive rewards; and
providing a keep-alive reward to the AP owner and the randomly selected provider from the sponsor locked tokens, by the blockchain platform, based on receiving periodically by the blockchain a keep-alive state of the AP from the randomly selected provider through the radius server.

2. The method of claim 1, wherein an event registering the AP ID is recorded in an event database and wherein the radius server detects the event by monitoring the event database.

3. The method of claim 2, wherein the event registering the AP ID is recorded in an MPT.

4. The method of claim 1, further comprising:
providing a blockchain data usage reward to the AP owner and the randomly selected provider from the sponsor locked tokens, by the blockchain platform, based on receiving by the blockchain data usage messages of the AP from the randomly selected provider through the radius server.

5. The method of claim 1, further comprising:
receiving, by the blockchain, from an operator, through the radius server, an authorizing transaction about a user connecting a user device through the AP starting a connectivity session with a session id.

6. The method of claim 5, wherein the operator is a first sponsor in the plurality of sponsors and the radius server is a second sponsor in the plurality of sponsors.

7. The method of claim 5, further comprising:
providing a user data usage reward to the AP owner and the randomly selected provider from the sponsor locked tokens, by the blockchain platform, based on receiving a user data usage message from the user device through the randomly selected provider.

8. The method of claim 1, wherein the plurality of sponsors is an entity selected from a group consisting of a corporation, a consortium, a governing jurisdiction, the AP owner, an operator, the blockchain platform, and a utility.

9. The method of claim 1, further comprising:
receiving terms of service S (S1, S2, ..., Sn) by the blockchain platform from connectivity service providers P (P1, P2, ... Pi, ..., Pn) based on terms set by a plurality of access points AP (AP1, AP2, ...APi, ..., APn);
recording the terms of service S (S1, S2, .., Sj, ..., Sn) wherein the each terms of service Si is set by the each service provider Pi for the each access point APi in an augmented network smart contract (ANSC);
receiving tokens T (T1, T2, Tj, ..., Tn) from sponsors C (C1, C2, Ck, ..., Cm) of the connectivity services;
populating reward pools from the received tokens;
receiving an acceptance of the terms of service Si from a operator Ok from a plurality of operators O (O1, O2, ... Ok, .., Op) of the connectivity services;
notifying the provider Pi of the acceptance of the terms of service Si;
updating an ANSC state with a user session including a provider id, a session id, and an AP id,
receiving, by the ANSC, the session ID, and usage through the provider Pi; and
rewarding the provider Pi and the APi based on keep-alive and data usage according to the terms of service Si from AP messages of the APi and user messages from a user device.

10. The method of claim 9, wherein the usage is identified in a QoS message sent on behalf of a user from the user device of the connectivity services.

11. The method of claim 10, wherein the QoS message includes a user id, a provider id, a session id, an amount of data transferred, a QoS data, a timestamp, and a signature.

12. The method of claim 11, wherein the QoS data includes a download speed, an upload speed, and a latency.

13. The method of claim 12, wherein the user device is a mobile device and the QoS message is sent automatically by the mobile device registered on behalf of the user and the QoS message is sent to the provider Pk.

14. The method of claim 13, wherein the terms of service Si are adjusted automatically according to the ANSC based on a number of connections to the APi providing the connectivity service.

15. The method of claim 14, wherein the provider Pi and the access point APi is penalized based on the APi staked tokens when the terms of service Si is not met.

16. The method of claim 15, wherein the terms of service Si include an identification, a price, a minimum cost, a maximum cost, a download transfer rate, an upload transfer rate.

17. The method of claim 9, wherein the sponsor Ck specifies a first portion of the sponsor Ck locked tokens for rewarding the first access point APi and the provider Pi.

18. The method of claim 17, wherein the sponsor Ck specifies a second portion of the sponsor Ck locked tokens for rewarding a second access point APk and the provider Pk.

19. The method of claim 18, wherein the sponsor Ck locks addition tokens to form sponsor Ck additional locked tokens and specifies a third portion of the additional locked tokens for rewarding the first access point APi and the provider Pi.

20. The method of claim 1, wherein the blockchain platform is a sponsor and generates tokens for paying the AP owner and the randomly selected provider.

21. The method of claim 1, wherein the user registers to the blockchain and the blockchain provides connectivity services to the user without requiring payment from the user and wherein the plurality of sponsors provide funding.

22. The method of claim 1, wherein the AP owner replaces the randomly selected provider with a different randomly selected provider.

23. An information handling system supporting an AP connecting to a blockchain platform via a Radius Server communicating with the AP, an operator, and a sponsor to dynamically reward for connectivity services comprising:
one or more processors;
a memory coupled to at least one of the processors;
a network interface that connects a local device to one or more remote web sites; and
a set of computer program instructions stored in the memory and executed by at least one of the processors in order to perform actions comprising:
installing on the Radius Server a glue service to the AP, provider, and the operator;
receiving by the blockchain platform an AP registration request for the AP wherein the registration request includes an owner ID for an AP owner registered on the blockchain platform and an AP serial number;
responsive to receiving the AP registration request by the blockchain, assigning an AP ID, registering the AP ID with a randomly selected provider, and recording the state change;
registering the AP ID on a radius server based on detecting the recorded state change;
locking AP owner tokens from the AP owner for a first period of time to form locked AP owner staked tokens to receive rewards;
locking sponsor tokens from a plurality of sponsors for a second period of time to form sponsor locked tokens;
locking provider tokens from the randomly selected provider associated with the AP for a third period of time to form provider staked tokens to receive rewards; and
rewarding the AP owner and the provider from the sponsor locked tokens, by the blockchain platform, based on receiving periodically, by the blockchain, a keep alive state of the AP from the provider through the radius server.

24. The information handling system of claim 23, wherein the state change is recorded in an event database.

25. The information handling system of claim 24, wherein the state change is recorded in an MPT.

26. The information handling system of claim 23, wherein rewards are provided to the AP owner and the provider from the sponsor locked tokens, by the blockchain platform, based on receiving user data usage messages from a user device through the provider.
